(19) United States
(12) Patent Application Publication
(10) Pub. No.: US 2004/0154337 A1
(43) Pub. Date: Aug. 12, 2004

(54) Manufacturing method for optical fiber grating

(76) Inventors: Hideyuki Iwamura, Tokyo (JP); Akihiko Nishiki, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/772,448

(22) Filed: Feb. 6, 2004

(30) Foreign Application Priority Data
Feb. 7, 2003 (JP) 031456/2003

(51) Int. Cl. C03B 37/01

(52) U.S. Cl. 65/425

(57) ABSTRACT

The present invention is a manufacturing method for an optical fiber grating which can decrease the light intensity at the bottom wavelength in the reflection or transmission spectrum to be sufficiently small. This method is comprised of a grating creation step and a phase adjustment step. The grating creation step is a step of creating a plurality of grating sections with different Bragg wavelengths arrayed in series in the longitudinal direction of this optical fiber, sandwiching the phase adjustment sections on an optical fiber made of a material which induces a light induced refractive index change phenomena. The phase adjustment step is a step of adjusting the light intensity at the bottom wavelength in the reflection or transmission spectrum of this optical fiber grating by irradiating the ultraviolet light only to the phase adjustment section while monitoring the transmittance or reflectance spectrum of the optical fiber grating after the grating step.

### BACKGROUND OF THE INVENTION

1. Field of the Invention

The present invention relates to a manufacturing method for optical fiber grating.

2. Description of Related Art

An optical fiber grating is an optical fiber where at least one of the core and the clad constituting the optical fiber has a periodical refractive index change structure (may be referred to as “Bragg grating” herein below). This optical fiber has a characteristic where light with a specific wavelength λ corresponding to the period Λ of the refractive index change structure of the Bragg grating (this wavelength λ may be referred to as a Bragg wavelength) is selectively reflected. The period Λ and the wavelength λ has the relationship λ=2nΛ, and this condition is referred to as a Bragg reflection condition. Here, n is an effective refractive index which determines the phase velocity of the light propagating through the optical fiber. The effective refractive index will be described in detail later.

Generally the above mentioned Bragg grating is formed at predetermined locations along the longitudinal direction of the optical fiber, and the other portion has the structure of an ordinary optical fiber where the effective refractive index is not modulated. In this description, the longitudinal direction of the optical fiber means a direction along the light propagation direction, and a direction in parallel with the central axis of the optical fiber. Also the optical fiber grating includes not only an optical fiber having a structure where the Bragg grating is created along the entire length of the optical fiber, but also an optical fiber which includes the sections where the Bragg grating is not created, in other words, an optical fiber where portions in which the Bragg grating is created and portions in which the Bragg grating is not created are integrated continuously in the longitudinal direction. In the optical fiber grating, the section where the Bragg grating is created may be referred to simply as the grating section herein below.

The refractive index change structure is created using a light induced refractive index change phenomena. The light induced refractive index change phenomena is, for example, a phenomena where the refractive index increases if ultraviolet light without about a 240 nm wavelength is irradiated to a quartz glass to which germanium is added.

Optical fiber grating is manufactured, for example, as follows. An optical fiber, where at least one of core and clad is created using germanium added quartz glass, is used. On the side face of this optical fiber (side face along the light propagation direction), ultraviolet light is irradiated along the longitudinal direction of the optical fiber at a predetermined period, then the effective refractive index of the exposed portion of the optical fiber increases, and the periodic structure of the effective refractive index is created along the propagation direction of the light which propagates inside the optical fiber.

The effective refractive index is a physical quantity which is determined corresponding to the propagation form of the photoelectric field propagating the optical guide, such as an optical fiber (called the wave guiding mode), and corresponds to the refractive index for determining the phase velocity of the light which propagates through this optical wave guide in this wave guiding mode. When light propagates through the wave guide, the propagating photoelectric field partially enters the clad portion. Therefore the refractive index, which the propagating light receives, is the mid-value between the refractive index of the core position and the refractive index of the clad portion. In other words, the effective refractive index is a value which is greater than the refractive index of the core and smaller than the refractive index of the clad.

Therefore if the refractive index is modulated for the clad of the optical wave guide, the effective refractive index of the light which propagates this optical wave guide is also modulated. In other words, in order to create the Bragg grating in the optical fiber, it is necessary to manufacture at least one of the core and the clad constituting the optical fiber using a material which causes a light induced refractive index change phenomena, such as germanium added quartz glass. Also it is necessary to create the refractive index modulation structure in at least one of the core and the clad.

Specifically, known methods for irradiating ultraviolet light in a predetermined period along the longitudinal direction of the optical fiber are, for example, the holographic method and the phase mask method. The effective refractive index may be referred to simply as the refractive index, within the range where no misunderstanding occurs.

The periodical structure of the refractive index created in the optical fiber by the above mentioned methods functions as the Bragg grating for the light propagating the optical fiber.

Optical fiber grating has a wide application range in the field of optical communication devices, since the connectivity with communication lines is good, and the optical characteristics, including the central wavelength of Bragg reflected waves and reflectance, can be easily adjusted during creation.

Good connectivity with communication lines means that it is unnecessary to perform complicated positional adjustments, and also that it is unnecessary to use many components, such as lens, to connect the communication lines and such elements as an optical fiber. In optical communication, an optical fiber is used as the communication line. The optical fiber grating has basically the same geometric shape as the optical fiber used for a communication line. Therefore the optical fiber used for a communication line and the optical fiber grating can be connected without a complicated adjustment operation if such ready made components as an optical fiber connecter is used.

Application examples of optical fiber grating is as follows. A first example is an application to be used as a multi-wavelength light source component used for wavelength division multiplexing (WDM) (see Japanese Patent Application Laid-Open No. 2000-19335). The invention disclosed in the Japanese Patent Application Laid-Open No. 2000-19335 is comprised of a light source which has a wide spectrum width which includes all the lights used for WDM (optical carrier wave), and a filter means for filtering out the light which has a narrow spectrum width to be allocated to each channel of WDM for the lights outputs from the light source. Optical fiber grating is used for this filter means.

A second example is an application to an encoder and decoder of optical code division multiplexing (OCDM) (e.g. Japanese Patent Application Laid-Open No. 2000-209186). In the invention disclosed in Japanese Patent Application Laid-Open No. 2000-209186, optical fiber grating is used as the means for encoding and decoding.

The optical fiber grating disclosed in Japanese Patent Application Laid-Open No. 2000-19335 and No. 2000-209186 has at least two types of Bragg gratings with different Bragg wavelengths which are created in serial in the longitudinal direction of the optical fiber with a predetermined interval. The optical fiber grating with this structure has characteristics which selectively reflects the light with a specific wavelength corresponding to the period of all the created Bragg gratings (lights with the same number of wavelengths as the number of created Bragg gratings).

However, in order to increase the wavelength multiplicity (that is to increase the number of channels) in WDM and OCDM, it is necessary to decrease the wavelength difference of the light carrier waves between channels (interval of the central wavelengths of the light carrier waves of the adjacent channels). The light carrier wave is light which is modulated for carrying signals in such optical communication as WDM and OCDM (this also may be called a light wave). The area of wavelengths of the light carrier waves that can propagate through a communication line (comprised of optical fibers) in optical communication is limited. Therefore if the number of channels to be multiplexed is increased, then the wavelength difference of the light carrier waves between the channels must be decreased accordingly. In other words, as the interval of the central wavelengths of the wavelength spectrum (called the “main lobe” herein below) of an individual light carrier wave to be distributed for each channel decreases, the area where the adjacent main lobes overlap increases relatively. Hereafter the wavelength spectrum of the light carrier waves may be simply called the spectrum of light carrier waves.

The area where main lobes overlap is the wavelength area between the central wavelengths of the light optical carrier waves. Hereafter the wavelength which is in this wavelength area and at which the light intensity becomes the minimum is called the “bottom wavelength between main lobes”, or simply the “bottom wavelength”, and the position at which the wavelength spectrum of the light carrier waves becomes the minimum may simply be called the “bottom”. The wavelength with which the light intensity of the main lobe becomes the maximum is called the “peak wavelength of the main lobes” or simply the “peak wavelength”, and the position at which the wavelength spectrum of the light carrier waves becomes the maximum may simply be called the “peak”.

When the area where the adjacent main lobes overlap increases relatively, the light intensity at the bottom wavelength relatively increases. In other words, when the light intensity at the bottom wavelength inevitably approaches the light intensity at the peak wavelength, identifying an individual main lobe becomes increasingly difficult. If it is difficult to identify an individual main lobe, then the invention disclosed in Japanese Patent Application Laid-Open No. 2000-19335 and No. 2000-209186 cannot be implemented.

In other words, when the optical fiber grating is used as an optical demultiplexer or optical multiplexer for the light carrier waves, the light to be demultiplexed or multiplexed is distributed for each channel, and plays a role as an light carrier wave, so it is necessary to identify the main lobe of the spectrum of reflected light or the transmitted light of the optical fiber grating.

To solve the above problem, it is an object of the present invention to provide a manufacturing method for an optical fiber grating which can decrease the light intensity of the bottom wavelength in reflection or transmission spectrum sufficiently to be able to identity the main lobes of the spectrum of reflected light or transmitted light.

### SUMMARY OF THE INVENTION

After study, the inventor of the present application obtained the follow conclusion. When an optical fiber grating where at least two types of Bragg gratings with a different Bragg wavelength are disposed in serial in the longitudinal direction of the optical fiber with a predetermined interval (this portion is hereafter called the “phase adjustment section”), the above problem can be solved by adjusting the length or the effective refractive index of the phase adjustment section.

For example, consider the reflection spectrum of an optical fiber grating where there exist two types of Bragg gratings with Bragg wavelengths λ₁ and λ₂. The bottom wavelength to which the main lobe of the individual reflection spectrum of these two types of Bragg gratings relates to is approximately (λ₁+λ₂)/2. The light intensity at the bottom wavelength of the reflection spectrum of this optical fiber grating can be adjusted by adjusting the length or the value of the effective refractive index of the phase adjustment section. Therefore the optical fiber grating can be manufactured such that the light intensity of the bottom wavelength becomes sufficiently small.

With an optical fiber grating which has a plurality of gratings with Bragg wavelength λ₁ (i=1, 2, 3, . . . N (where N is a natural number)) as well, the same object can be achieved by adjusting the length or the effective refractive index of the phase adjustment section between the grating sections created adjacent to each other.

With the foregoing in view, the manufacturing method for an optical fiber grating of the present invention was developed based on the result of the above mentioned study, and is comprised of a grating creation step and a phase adjustment step, as described below.

The grating creation step is a step of creating grating sections, having a structure in which the refractive index periodically changes along the longitudinal direction of the optical fiber, in the optical fiber, sandwiching the phase adjustment section with changing the period of the refractive index change from one another. The phase adjustment step is a step of adjusting the optical length of the phase adjustment section while monitoring the spectrum of the reflectance of the optical fiber grating where the grating sections and the phase adjustment sections are disposed.

In other words, the optical fiber is comprised of a core and a clad which is disposed around the core, wherein at least one of the core and the clad is made of a material of which the refractive index is increased by irradiating a first light. The grating section is created by irradiating the first light at a predetermined period along the longitudinal direction of this optical fiber.

This grating section is created in series at a plurality of locations in the longitudinal direction of the optical fiber with a predetermined interval. The refractive index modulation period of these grating sections, however, is different. In other words, the Bragg wavelengths of these grating sections are different.

Then while monitoring the spectrum of the reflectance of the optical fiber grating where the grating sections and the phase adjusting sections are created, a second light is irradiated only to the phase adjustment sections, so as to adjust the optical characteristics of the optical fiber grating (phase adjustment step).

In other words, the phase adjustment step is a step of allowing a third light to enter the core of the optical fiber, and allowing the reflected light, which is reflected from the grating section of the optical fiber, to enter the light intensity measuring instrument, and while observing the spectrum of this reflected light, ending the irradiation of the second light at the point when the minimum value of the spectrum of the reflected light between the main lobes becomes the smallest. Certainly the same object can be achieved by observing the spectrum of transmittance instead of the spectrum of the reflectance of the optical fiber grating. In the phase adjustment step, whether the spectrum of the reflection is observed or the spectrum of the transmission is observed is determined depending on the device where the optical fiber grating is integrated, which is a simple design issue of the step.

The third light here is a light with a wavelength of which the device, where the optical fiber grating is integrated, is assumed to use. In other words, when the optical fiber grating is integrated into an optical communication device, the third light is a light carrier wave. Also a method for creating the grating section by exposing a pulse eximer laser (ultraviolet) with a 248 nm wavelength as the first and second lights is now known. Hereafter the first and second lights are described as ultraviolet lights with a wavelength near 240 nm, which causes a light induced refractive index change phenomena.

When an optical fiber which causes a light induced refractive index change phenomena using a light other than ultraviolet light is developed in the future, the present invention can be implemented using this light. Needless to say, an ion beam irradiation method can be applied to the present invention if a refractive index change phenomena is confirmed and the industrial effectiveness of this method is also confirmed.

According to the manufacturing method of the present invention, grating sections with different Bragg wavelengths are disposed in series at a plurality of locations in the longitudinal direction of the optical fiber, in the grating creation step, so if the reflection spectrum of this optical fiber grating is observed in a step immediately after the grating creation step ends, a reflection spectrum equal to the sum of the reflection spectrums of these grating sections can be obtained. In other words, the reflection spectrum of this optical fiber grating is main lobes, having the Bragg wavelength of the disposed grating section as the central wavelength, which are overlapped. Therefore the number of main lobes is the same as the number of disposed grating sections, and the bottom of the reflection spectrum is at the wavelength between the central wavelengths of adjacent main lobes.

Then in the phase adjustment step, ultraviolet light is continuously irradiated for a predetermined time only on the phase adjustment sections, and while observing the light intensity at the bottom, the point of time when the light intensity becomes smallest at the bottom can be determined. If irradiation of the ultraviolet light is ended when the light intensity at the bottom is smallest, then an optical fiber grating with the desired optical characteristics can be manufactured.

According to the manufacturing method of the present invention, the grating section may be created such that the amount of fluctuation of the refractive index (hereafter called the “refractive index modulation degree”), along the longitudinal direction of the optical fiber grating, becomes smaller approaching closer to both ends of the grating section (hereafter called “apodization”). When the refractive index modulation degree is apodized, the reflection spectrum component, which appears small at both ends of the main lobe (hereafter may be called the “side lobe”), can be suppressed, as mentioned later. For the optical fiber grating having this apodized grating section as well, the light intensity at the bottom wavelength in the reflection or transmission spectrum, which is an optical characteristic of the optical fiber grating, can be sufficiently decreased in the above mentioned phase adjustment step.

### BRIEF DESCRIPTION OF THE DRAWINGS

The foregoings and other objects, features and advantageous of the present invention will be better understood from the following description taken in connection with the accompanying drawings, in which:

FIG. 1 is a diagram depicting the structure of the optical fiber grating;

FIG. 2 is a diagram depicting the creation method for the optical fiber grating;

FIG. 3 is a diagram depicting the operational principle of the multi-wavelength light source unit;

FIG. 4(A) is a diagram depicting the spectrum of the light source of the multi-wavelength light source unit, and FIG. 4(B) is a diagram depicting the spectrum of the output light from the multi-wavelength light source unit;

FIGS. 5(A) and 5(B) are diagrams depicting the spectrum of the output light from the multi-wavelength light source unit;

FIG. 6 is a diagram depicting the OCDM system;

FIGS. 7(A) to 7(C) are diagrams depicting the relationship of the light carrier waves on a time axis;

FIGS. 8(A) to 8(C) are diagrams depicting filtering by the optical fiber grating;

FIGS. 9(A) to 9(D) are diagrams depicting the manufacturing steps of the optical fiber grating;

FIG. 10 is a diagram depicting the refractive index distribution structure of the optical fiber grating according to the first embodiment;

FIG. 11 is a diagram depicting the reflection spectrum to be observed in step B;

FIG. 12 is an enlarged view of the b₁₂ portion of the reflection spectrum to be observed in steps B;

FIG. 13 is a diagram depicting the reflection spectrum to be observed in step D;

FIG. 14 is an enlarged view of the reflection spectrum to be observed in step D, where a is an enlarged view of the b₁₂ portion and b is an enlarged view of the b₂₃ portion;

FIGS. 15(A) and 15(B) are diagrams depicting the apodization principle of the Bragg grating;

FIGS. 16(A) and 16(B) are diagrams depicting the reflection spectrum of the optical fiber grating;

FIG. 17 is a diagram depicting the transmittance characteristics of the transmittance distribution mask;

FIGS. 18(A) and 18(B) are diagrams depicting the manufacturing steps of the apodized optical fiber grating;

FIG. 19 is a diagram depicting the refractive index distribution structure of the optical fiber grating according to the second embodiment;

FIG. 20 is a diagram depicting the reflection spectrum to be observed in step B′;

FIG. 21 is an enlarged view of the b₄₅ portion of the reflection spectrum to be observed in step B′;

FIG. 22 is a diagram depicting the reflection spectrum to be observed in step D′; and

FIG. 23 is an enlarged view of the reflection spectrum to be observed in step D′, where a is an enlarged view of the B₄₅ portion and b is an enlarged view of the b₅₆ portion.

### DESCRIPTION OF THE PREFERRED EMBODIMENTS

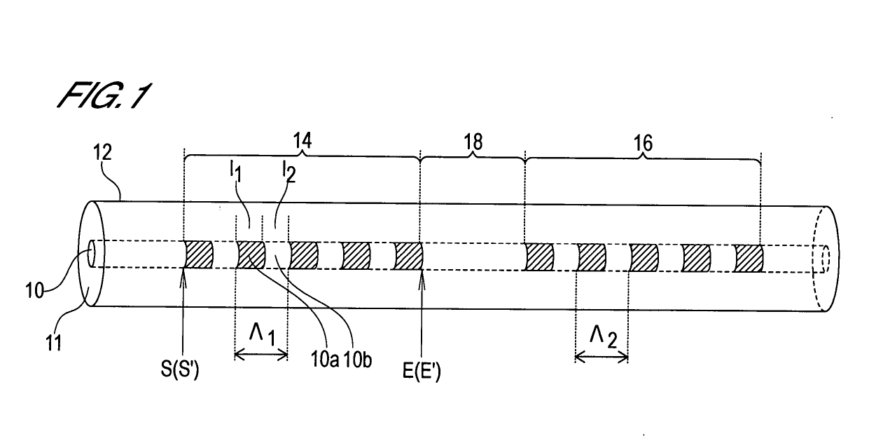

Embodiments of the present invention will now be described with reference to FIG. 1 to FIG. 23. These drawings merely present the shape, size and positional relationship of the composing elements in a general sense, sufficient to assist in the understanding of the present invention, and also the numeral and other conditions in the following description are merely preferred examples, and the present invention is not in any way limited by these embodiments of the invention. In each drawing, identical numbers are denoted for similar composing elements, for which redundant description is omitted.

With reference to FIG. 1, a structure of an optical fiber grating, where the grating sections are created at a plurality of locations (two locations in FIG. 1) and which is used as an optical demultiplexing function element or an optical multiplexing function element for light carrier waves in optical communication, will be described. To simplify the description, the case of an optical fiber grating, which is created by performing periodic refractive index modulation on the core using germanium added quartz glass, as an example of material that causes a light induced refractive index change phenomena on the core of optical fiber, will be described below. In the following description, the method for creating a grating section can not only be a method of applying a periodic refractive index modulation on the core to be described below, but also can be applying the periodic refractive index modulation on the clad, or on both the core and the clad.

The optical fiber grating can be created not only for an optical fiber created by using material which causes a light induced refractive index change phenomena, but also for an ordinary optical fiber where a light induced refractive index change phenomena does not occur, by using an ion implantation induced refractive index change phenomena. In either case, the technical concept of the present invention, that is adjusting the optical characteristics of the optical fiber grating by adjusting the optical length of the phase adjustment section, can be used.

The optical fiber grating 12, shown in FIG. 1, is comprised of a core 10, a clad 11, and a first grating section 14 of which the Bragg wavelength is λ₁, and a second grating section 16 of which the Bragg wavelength is λ₂. The relationship between the Bragg wavelength and the refractive index period of the grating section is as follows.

The first grating section 14 will be described as an example. In the core 10, it is assumed that the length of the high refractive index portion 10a is l₁, and the length of the low refractive index portion 10b is l₂.

In FIG. 1, the high refractive index portion 10a is shaded. In FIG. 1, the low refractive index portion 10b is unshaded. And it is assumed that the effective refractive index of the high refractive index portion 10a is n₁ and the effective refractive index of the low refractive index portion 10b is n₂. In this case, the Bragg conditions, that is the conditions to provide a wavelength of light to be reflected is

λ₁/2=n₁l₁+n₂l₂ (1)

Here λ₁ is a peak wavelength (Bragg wavelength) of the reflection spectrum of the first grating section 14.

Since the value n₁-n₂ is about 5×10⁻³ in the case of an optical cable of which a core is germanium added quartz glass, the values n₁ and n₂ are approximated as n₁=n₂=n, therefore the formula (1) can be approximated to be the following formula (2).

λ₁=2(n₁l₁+n₂l₂)≈2n(l₁+l₂)=2nΛ₁ (2)

Here Λ₁ is a period of refractive index change of Bragg grating.

Therefore hereafter it is assumed that the Bragg conditions are given by the formula (2). Approximate effective refractive index n may be regarded as about n=(n₁+n₂)/2.

Therefore the reflection spectrum of the optical fiber grating with the structure shown in FIG. 1 has peaks at wavelengths λ₁ and λ₂. Here λ₁=2nΛ₁ and λ₂=2nΛ₂. FIG. 1 shows the case when the refractive index sharply changes at the boundary between the high refractive index portion and the low refractive index portion, but the above mentioned content is the same even if the refractive index changes smoothly, such as the case of being modulated in a sine function form. In other words, the relationship between period Λᵢ of the Bragg grating and the Bragg wavelength λᵢ is still given by the formula (1) or the formula (2). Here i is a natural number, and the period of the Bragg grating and the Bragg wavelength are distinguished by the suffix i. Λᵢ is a period corresponding to the wavelength λᵢ. In the later mentioned embodiment, the refractive index modulation of the Bragg grating in the optical fiber grating to be the target is a sine function form.

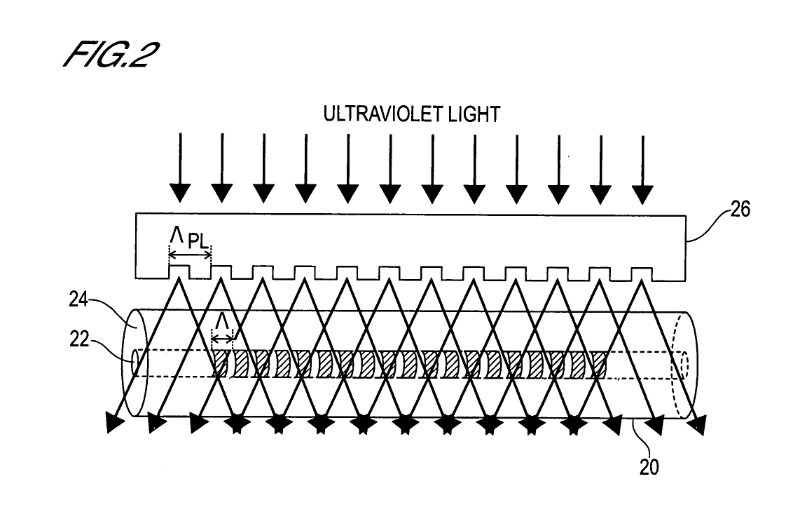

With reference to FIG. 2, a method for creating the grating section in the optical fiber will be described. In order to create the optical fiber grating, an optical fiber, where at least one of the core and the clad constituting the optical fiber is made of a material which causes a light induced refractive index change phenomena, such as germanium added quartz glass, is used.

Here an optical fiber created using germanium added quartz glass for the core will be described as an example. The principle of the creation method is the same in the case of creating the optical fiber grating using an optical fiber which is created using a material which causes a light induced refractive index change phenomena for a clad, not a core, or for both the core and the clad.

Here a method for creating the Bragg grating using the phase grating as a mask will be described, but the Bragg grating may be created by the holographic method.

The phase grating 26 is positioned close to the optical fiber 20, and ultraviolet light is irradiated from above. In FIG. 2, the phase grating 26 is disposed above and close to the optical fiber 20, in parallel with the central axis of the optical fiber 20. The appropriate wavelength of the ultraviolet light is about 240 nm, and an eximer laser is appropriate to be used as a light source to obtain the ultraviolet light. On the phase grating 26, periodic bumps are created on such a transparent material as quartz glass, which transmits ultraviolet light, as shown in FIG. 2. When the ultraviolet light is irradiated as shown in FIG. 2, periodic density variation of ultraviolet light intensity is created on the core 22 of the optical fiber 20 by the interference of diffracted light from the bump structure of the phase grating 26. In other words, ultraviolet light, of which intensity periodically changes along the longitudinal direction of the optical fiber 20, can be irradiated on the core 22 through the clad 24.

The refractive index rises in the portion where the ultraviolet light is irradiated, so as a result, periodic refractive index modulation can be created in the longitudinal direction of the core 22. The density variation structure of the ultraviolet light intensity is a sine function form, so the refractive index modulation structure to be created becomes a sine function form.

The phase modulation period (equal to the period of the bump structure) of the phase grating 26 and the period of the refractive index modulation structure to be created in the core 22 of the optical fiber 20 are determined by a known optical theory. In other words, if the Bragg wavelength λ of the grating section to be created is given, then the period Λ of the Bragg grating is determined, therefore the phase modulation period Λ_{PL}of the corresponding phase grading 26 can be uniquely determined as Λ_{PL}=2Λ by a known optical theory.

In order to create the optical fiber grating shown in FIG. 1, where the grating section is created at two locations, a phase grating for creating the first grating section 14 and a phase grating for creating the second grating section 16 are prepared respectively. Then the two types of phase gratings are placed at an interval, and ultraviolet light is exposed so as to create the phase adjustment section 18. Needless to say, during this exposure, the phase adjustment section 18 is protected from irradiation by the ultraviolet light.

Before exposing the ultraviolet light, a known technology, to improve the efficiency of the changing refractive index by ultraviolet light irradiation, may be used, such as performing hydrogen (H) osmosis into the optical fiber, or by adding boron (B).

Also an optical fiber grating having similar characteristics as the above mentioned optical fiber grating can be manufactured by using an ion implantation induced refractive index change phenomena for an ordinary optical fiber where a light induced refractive index change phenomena does not occur. In this case, the optical fiber grating can be manufactured only if the optical fiber to be used can cause an ion implantation induced refractive index change phenomena. Almost all the optical fibers currently available fall under the category of optical fibers which cause an ion implantation induced refractive index change phenomena.

In order to manufacture an optical fiber grating using an ion implantation induced refractive index change phenomena, a mask where slits are created in a period, the same as the period Λ of the Bragg grating, is used instead of the phase grating 26, and an ion beam is used instead of ultraviolet light.

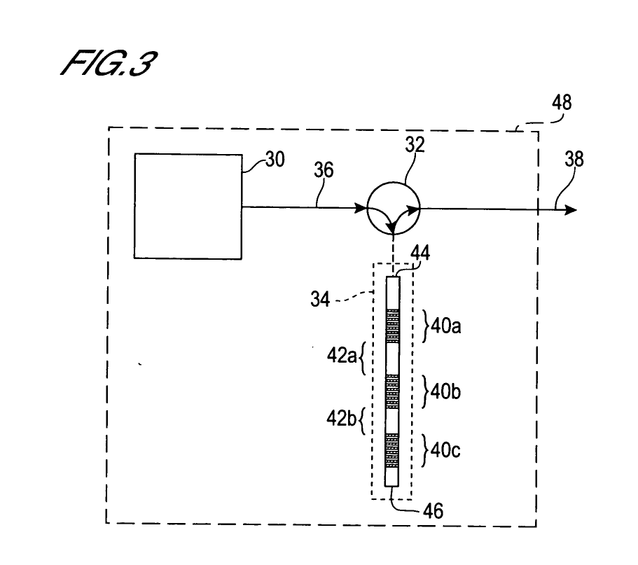

With reference to FIG. 3, the multi-wavelength light source unit for wavelength division multiplexing disclosed in Japanese Patent Application Laid-Open No. 2000-19335 will be described as an application example of the above mentioned optical fiber grating. Here the purpose of describing the configuration of the multi-wavelength light source unit for wavelength division multiplexing and the functions thereof is to assist in understanding the optical characteristics which the optical fiber grating, to be used for the multi-wavelength light source unit, should have as a wavelength filter.

As FIG. 3 shows, the above mentioned multi-wavelength light source unit 48 is comprised of a wideband spectrum light source 30, optical circulator 32 and optical fiber grating 34.

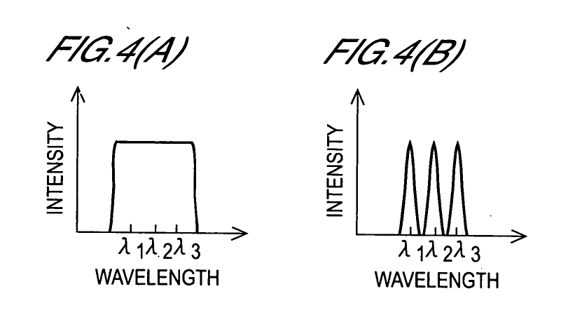

The wideband spectrum light source 30 is a light source which has a wide emission spectrum, of which the emission wavelength range includes all of the wavelength range of at least the plurality of light carrier waves to be used. For example, the wideband spectrum light source 30 can be comprised of a super-luminescent diode. From the wideband spectrum light source 30, light with a wideband emission spectrum, as shown in FIG. 4(A), is emitted. In FIG. 4(A), the abscissa indicates the wavelength in an arbitrary scale, and the ordinate indicate the light intensity in an arbitrary scale.

The output light 36 of the wideband spectrum light source 30 enters the optical circulator 32, and is guided from the optical circulator 32 to the optical fiber grating 34. In FIG. 3, the optical fiber grating 34 is a cross-sectional view of the optical fiber grating shown in FIG. 1, when the cutting plane is a plane, that includes the center of the core along the center of the core. In the optical fiber grating 34, however, the grating section is created not at two locations but at three locations. In other words, in the optical fiber grating 34, the grating sections 40a, 40b and 40c are disposed sandwiching the gap 42a and gap 42b respectively, along the direction from the incident end 44 to the termination end 46, and are set such that the Bragg wavelengths of the grating sections become λ₁, λ₂ and λ₃ respectively.

The output light 36 from the light source 30 enters the optical fiber grating 34 via the optical circulator 32, lights with wavelengths λ₁, λ₂ and λ₃ are selectively reflected from the grating sections 40a, 40b and 40c respectively, and these reflected lights enter the optical circulator 32 again. The reflected light which entered the optical circulator 32 is emitted outside as the output light 32 of the multi-wavelength light source unit 48. Therefore the spectrum of the output light 38 of the multi-wavelength light source unit 48 becomes the spectrum shown in FIG. 4(B). Lights other than lights with wavelengths λ₁, λ₂ and λ₃ are emitted from the termination end 46 of the optical fiber grating, and are not used as the output light of the multi-wavelength light source unit 48.

In order to increase multiplicity in the wavelength division multiplexing, the wavelength difference of the optical carrier waves between channels must be decreased, as described above. In other words, if the multi-wavelength light source unit is used as a light source in wavelength division multiplexing, as shown in FIG. 3, the above mentioned lights with wavelengths λ₁, λ₂ and λ₃ become lights to be allocated to each channel, and in order to increase multiplicity, the difference between the wavelengths λ₁ and λ₂ or the difference between the wavelengths λ₂ and λ₃ must be decreased while maintaining the status where the adjacent wavelength peak positions can be clearly distinguished from each other.

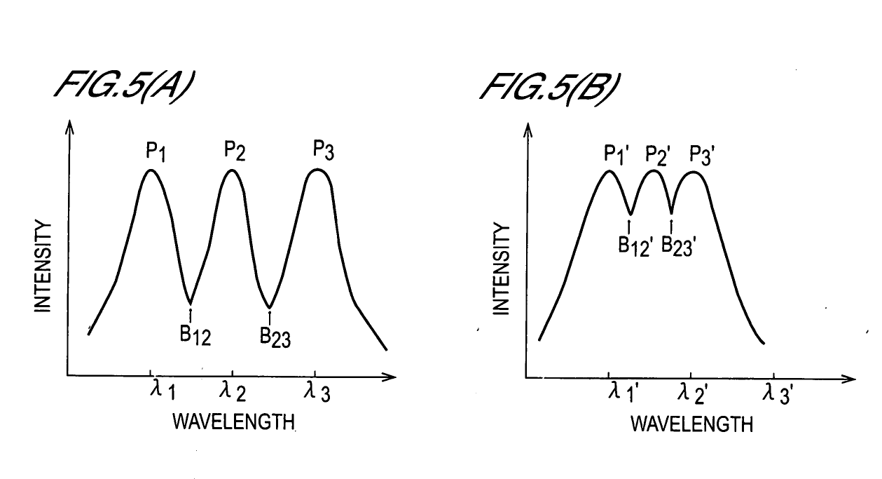

The above situation will be described with reference to FIG. 5(A) and FIG. 5(B). In FIG. 5(A) and FIG. 5(B), the abscissa indicates the wavelength in an arbitrary scale, and the ordinate indicates the light intensity in an arbitrary scale. FIG. 5(A) shows the case when the difference between the wavelengths λ₁ and λ₂ or the difference between the wavelengths λ₂ and λ₃ is sufficiently large, that is, the case when the difference of the wavelengths, with which the adjacent wavelength peak positions can be clearly distinguished from each other, exists. Bottoms exist between the respective peak positions P₁, P₂ and P₃ of the main lobes, corresponding to the wavelengths λ₁, λ₂ and λ₃. The bottom between the peak positions P₁ and P₂ and the bottom between P₂ and P₃ are assumed to be B₁₂ and B₂₃ respectively. Hereafter the peak positions P₁, P₂ and P₃ or the bottoms B₁₂ and B₂₃ not only mean the peak or bottom itself, but also means the wavelength which indicates the position where that peak or bottom exists, within the range where no misunderstanding occurs.

In FIG. 5(A), the light intensity of the bottom B₁₂ between the peak positions P₁ and P₂ and the light intensity of the bottom B₂₃ between the peak positions P₂ and P₃ are small enough to allow distinguishing each one of the main lobes corresponding to the wavelengths λ₁, λ₂ and λ₃ clearly, compared with the light intensity of the respective peak positions P₁, P₂ and P₃ of the main lobes.

FIG. 5(B), on the other hand, shows the case when the difference between the wavelengths λ₁′ and λ₂′ or the difference between the wavelengths λ₂′ and λ₃′ is small. In this case, the light intensity of the bottom B₁₂′ between the peak positions P₁′ and P₂′ and the light intensity of the bottom B₂₃′ between the peak positions P₂′ and P₃′ are smaller than the light intensity at the respective peak positions P₁′, P₂′ and P₃′ of the main lobes. Therefore each one of the main lobes corresponding to the wavelengths λ₁′, λ₂′ and λ₃′ cannot be clearly distinguished from each other.

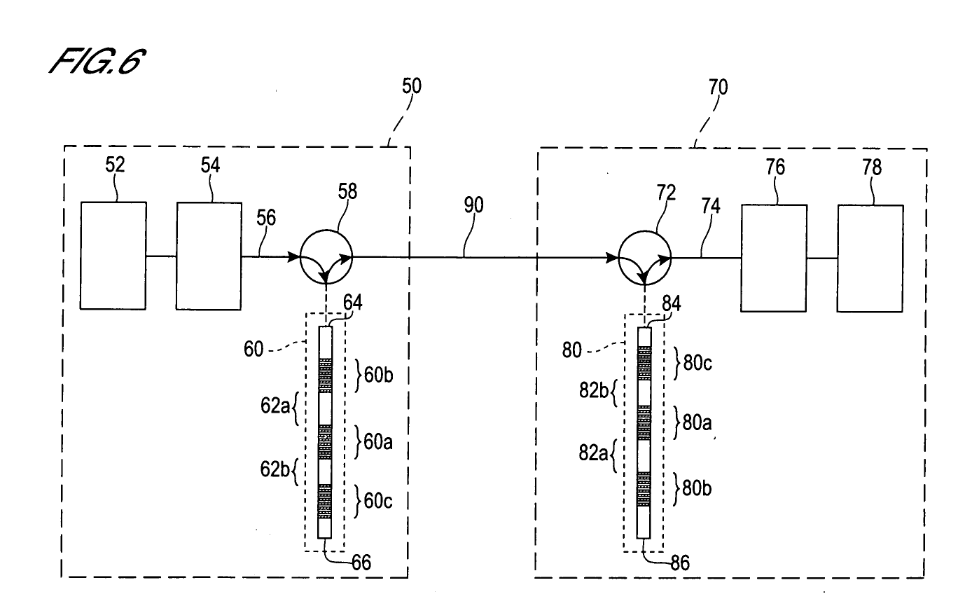

Now with reference to FIG. 6, the OCDM system disclosed in Japanese Patent Application No. 2000-209186 will be described as another application example of the above mentioned optical fiber grating. Here the purpose of describing the configuration of the OCDM system and the functions thereof is to assist in understanding the optical characteristics which the optical fiber grating to be used for the OCDM system should have as a wavelength filter.

The OCDM system shown in FIG. 6 is comprised of a transmitter 50 and a receiver 70 which are connected with an optical fiber 90.

The configuration of the transmitter 50 will be described first. The transmitter 50 is comprised of a light source 52, an optical modulator 54, a first optical circulator 58 and a first optical fiber grating 60. The light source 52 is a multi-wavelength light source which oscillates at high frequency, repeating a plurality of optical pulses with different wavelengths. Specifically, the light source 52 is a mode locked semiconductor laser diode. The optical pulse, which is output from the light source 52, enters the optical modulator 54, modulated to the data signals 56 to be transmitted, and enters the first optical fiber grating 60 via the first optical circulator 58. Hereafter the transmission path where the data signals 56 propagate is called the transmission path 56 to simplify description.

The first optical fiber grating 60 has three grating sections having different Bragg wavelengths. These grating sections are arranged in the sequence of grating sections 60b, 60a and 60c from the incident end 64 to the termination end 66 of the first optical fiber grating 60. The gap 62a is created between the grating sections 60b and 60a, and the gap 62b is created between the grating sections 60a and 60c. The Bragg wavelengths of these grating sections 60b, 60a and 60c are λ₂, λ₁ and λ₃ respectively.

The case when the data signals 56 to be transmitted is comprised of channel 2, channel 1 and channel 3, and each signal is transmitted by the light carrier waves of which the wavelengths are λ₂, λ₁ and λ₃ respectively will be described as an example. For the data signals 56 to be transmitted, the data signals of channel 2, channel 1 and channel 3, which are set in the light carrier OCDM system respectively, are at the same position of the time axis just before entering the optical fiber grating 60 via the first optical circulator 58.

When the data signals 56 enter the first optical fiber grating 60, the time, when each one of the light carrier waves of which the wavelengths are λ₂, λ₁ and λ₃ respectively reflects from each grating section and returns to the incident end 64, differs, because of the difference of the distance from the incident end 64 of the first optical fiber grating 60 to each of the three grating sections 60b, 60a and 60c. In other words, if the distances to the three grating sections are set so as to correspond to the time difference on the time axis of each channel in optical encoding, then when the optical pulses with a plurality of wavelengths enter the first optical fiber grating 60 simultaneously, the channel pulse (optical pulse string where the data signals to be transmitted are reflected) for the light carrier waves with different wavelengths, which are reflected by each grating section, are arranged at the incident end 64 in a predetermined sequence, and optical encoding is executed.

The data signals 56, which are optically encoded in this way, enter the first optical circulator 58 again, and are sent to the receiver 70 via the optical fiber (also called the “transmission path”) 90. Hereafter the data signals which propagate through the transmission path 90 may also be simply called the “data signals” 90.

Now with reference to FIG. 6, the structure of the receiver 70 will be described. The receiver 70 is comprised of the second optical circulator 72, photo-detector 76, threshold element 78 and the second optical fiber grating 80. The configuration of the second optical fiber grating 80, which constitutes the receiver 70, has the following features.

In other words, in the receiver 70, the second optical fiber grating 80 has grating sections which are arranged in a sequence which is in a mirror relationship with that of the grating sections of the first optical fiber grating 60 in order to optically decode the data signals 90 which are sent by propagation through the transmission path 90. In the first optical fiber grating 60, the grating sections are arranged in the sequence of the grating sections 60b, 60a and 60c of which the Bragg wavelengths are λ₂, λ₁ and λ₃ respectively from the incident end 64 to the termination end 66, but in the second optical fiber grating 80, the arrangement is in a mirror relationship with this.

Specifically, the grating sections are arranged in the sequence of the grating sections 80c, 80a and 80b of which the Bragg wavelengths are λ₃, λ₁ and λ₂ respectively from the incident end 84 to the termination end 86, and the gap 82b is disposed between the grating sections 80c and 80a, and the gap 82a is disposed between the grating sections 80a and 80b. It is set such that the Bragg wavelengths of the gratings 80c, 80a and 80c are λ₃, λ₁ and λ₂ respectively, and the dimensions of the gap 82b is the same as the dimensions of the gap 62b, and the dimensions of the gap 82a is the same as the dimensions of the gap 62a.

The optically encoded data signals 90, which propagated through the transmission path 90, enter the second optical fiber grating 80 via the second optical circulator 72. As described above, the three grating sections created on the second optical fiber grating 80 are arranged in a mirror relationship with the first optical fiber grating 60, including the gap sections thereof, so the optically encoded data signals 90, which propagated through the transmission path 90, are optically decoded. In other words, the arrival time differences, which are added to the light carrier wave of each channel, are canceled, and the light carrier wave of each channel is returned to the same position on the time axis again.

In this way, the data signals, optically encoded by the first optical fiber grating 60 of the transmitter 50, are optically decoded by the second optical fiber grating 80 of the receiver 70. The optically decoded data signals become data signals 74 via the second optical circulator, are photo-electric converted by the photo-detector 76, then the threshold is judged by the threshold element 78 and the data signals, which were sent, are separated into each channel and are received. Hereafter the transmission path, where the data signals 74 propagate, is called the “transmission path” 74 for simplification.

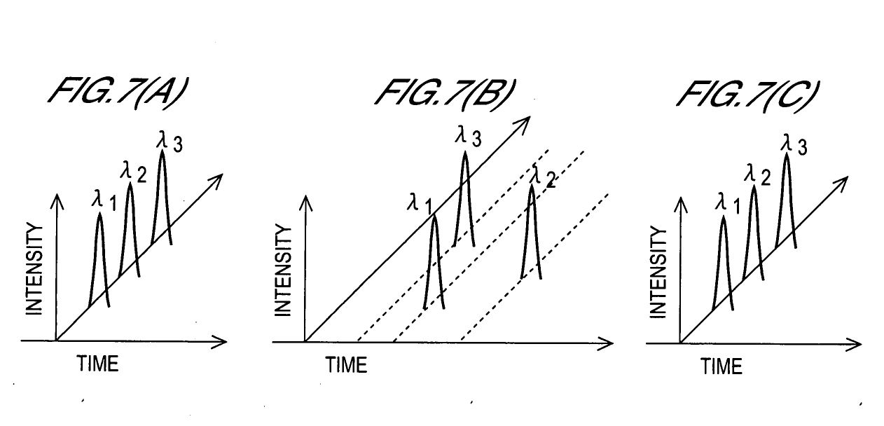

With reference to FIG. 7(A), (B) and (C), the relationship on the time axis of the light carrier waves which carry the data signals of each channel (in this case, three lights with wavelengths λ₁, λ₂ and λ₃) of the above mentioned OCDM system in the transmission lines 56, 90 and 74, will be described. FIG. 7(A) shows the relationship when the data signals are propagating through the transmission path 56, FIG. 7(B) shows the relationship when the data signals are propagating the transmission path 90, and FIG. 7(C) shows the relationship when the data signals are propagating the transmission path 74.

In FIG. 7(A), (B) and (C), the abscissa indicates the time, and the ordinate indicates the light intensity in an arbitrary scale respectively. Each channel is represented by one of the optical pulses of the three light carrier waves with wavelengths λ₁, λ₂ and λ₃. To make it easier to view, the optical pulses with wavelengths λ₁, λ₂ and λ₃ are drawn shifting up in a diagonal direction in FIG. 7(A), (B) and (C). So the shifting up space itself in a diagonal direction physically has no meaning.

For the data signals which are sent out to the transmission path 56 without any time difference, each channel is wavelength-multiplexed with the same phase, as shown in FIG. 7(A). These data signals 56 are optically encoded by the first optical fiber grating 60, and the phase of each channel is modulated, as shown in FIG. 7(B). In other words, in this case, the data signals 56 are optically encoded in the sequence of channel 2, channel 1 and channel 3. The data signals 90 optically encoded in this way are optically decoded by the second optical fiber grating 80 of the receiver 70, and as FIG. 7(C) shows, each channel is wavelength-multiplexed with the same phase, and optically decoded to the original status.

Now the case when the light intensity at the bottom is not small compared with the light intensity at the peak of the main lobe is considered in the Bragg reflection characteristic of the first optical fiber grating 60 constituting the transmitter 50. For example, this is the case when the reflection spectrum of the light carrier wave, which has a main lobe of which the peak is λ₁ (light carrier wave with wavelength λ₁), cannot be completely distinguished from the reflection spectrum of the optical carrier wave which has a peak at the adjacent wavelength λ₂. In this case, the spectrum form of the main lobe of the light carrier wave with wavelength λ₁, which is reflected from the first optical fiber grating 60, is asymmetric with respect to the peak wavelength. Therefore when the data signals are decoded by the second optical fiber grating 80 constituting the receiver 70, the data signals are not correctly decoded, that is optical decoding becomes difficult.

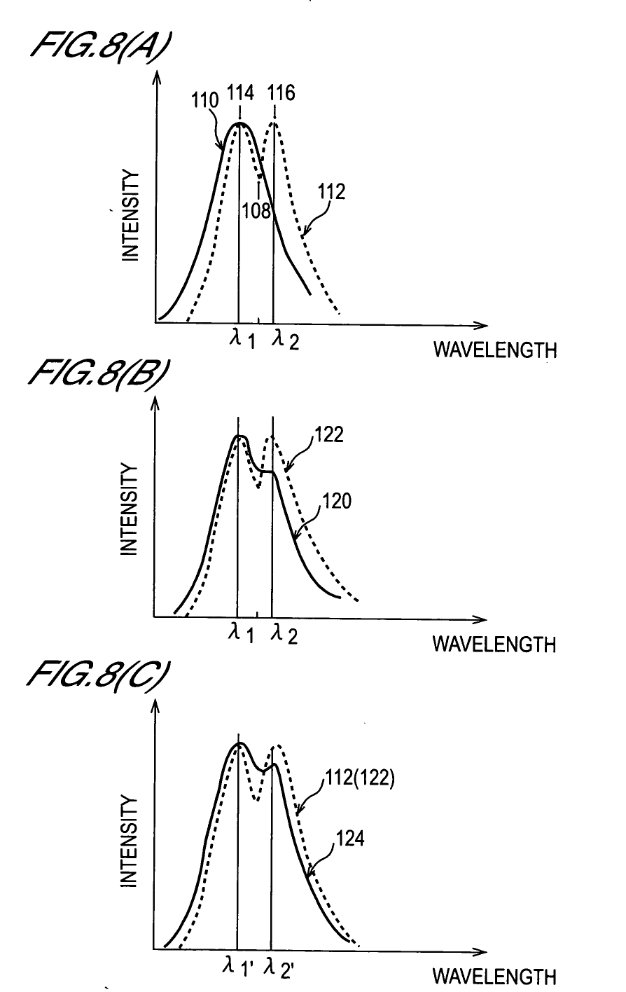

The above mentioned status where decoding becomes difficult will be described with reference to FIG. 8(A), (B) and (C). In FIG. 8(A), (B) and (C), the abscissa indicates the wavelength, and the ordinate indicates the light intensity. The scale of the light intensity on the ordinate is arbitrary.

FIG. 8(A) is a diagram depicting the case when optical encoding is executed in the first optical fiber grating 60, that is when the light carrier wave λ₁ is filtered by the first optical fiber grating 60. In FIG. 8(A), the curve 112, indicated by the broken line, is the reflection spectrum of the first optical fiber grating 60. The curve 110, indicated by the solid line, is the spectrum of the light carrier wave with wavelength λ₁. The reflection spectrum of the optical carrier wave with the wavelength λ₁ by the first optical fiber grating 60 is given by the product of the curve 112 and the curve 110, and this is given by the curve indicated by the solid line 120 in FIG. 8(B). In other words, the maximum spectrum strength is in the wavelength λ₁ and wavelength λ₂, and becomes an asymmetric form with respect to the peak wavelength λ₁.

The spectrum form of the light carrier wave with wavelength λ₁, which carries the data signals to be optically decoded, that is to be filtered by the second optical fiber grating 80 which constitutes the receiver 70, is shown by the curve indicated by the solid line 120 in FIG. 8(B). The spectrum form of the filtered light carrier wave with wavelength λ₁ is given by the product of the solid line 120 indicated in FIG. 8(B) and the broken line 122 which is the reflection spectrum of the second optical fiber grating 80, that is it is given by the curve indicated by the solid line 124 in FIG. 8(C).

Therefore the spectrum of the light carrier wave with the wavelength λ₁ is very different between the form before entering the first optical fiber grating 60 (given by the curve 110) and the form after emitting from the second optical fiber grating 80 (given by the curve 124). In other words, the spectrum form of the main lobe of the light carrier wave with the wavelength λ₁ is asymmetric with respect to the peak wavelength, therefore the data signals are not correctly decoded by the second optical fiber grating 80 which constitutes the receiver 70, and decoding becomes difficult.

So far the optical fiber grating has been described from the viewpoint of using the reflection spectrum thereof, but this is the same from the viewpoint of using the transmission spectrum. In other words, in the case of performing filtering using the transmission spectrum characteristic of the optical fiber grating as well, the adjacent main lobes cannot be clearly distinguished from each other unless the light intensity at the bottom wavelength is sufficiently small.

As described above, if the area, where the adjacent main lobes of the reflection or transmission spectrum of the optical fiber grating overlap, relatively increases, the light intensity at the bottom wavelength relatively increases. In other words, the light intensity at the bottom wavelength inevitably becomes closer to the light intensity at the peak wavelength, so identifying an individual main lobe becomes increasingly difficult. If identifying an individual main lobe is difficult, then the invention disclosed in Japanese Patent Application Laid-Open No. 2000-19335 or No. 2000-209186 cannot be implemented.

With the foregoing in view, the manufacturing method for an optical fiber grating which can solve the above problem will be described in the following embodiments.

First Embodiment

The first embodiment of the manufacturing method for optical fiber grating will be described, which is comprised of a grating creating step of creating grating sections with a structure where the refractive index periodically changes along the longitudinal direction of the optical fiber, with a different refractive index change period from one another, sandwiching the phase adjustment section, and a phase adjustment step of adjusting the optical length of the phase adjustment section while monitoring the spectrum of the reflectance of the optical fiber grating where the grating sections and the phase adjustment sections are disposed.

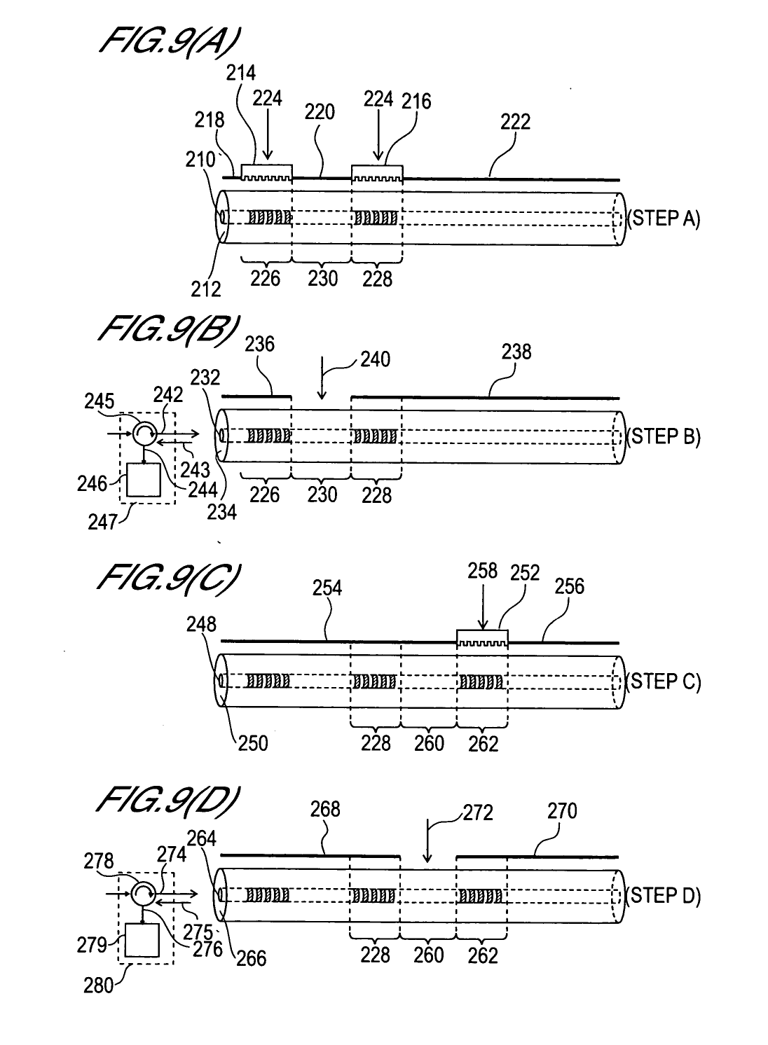

With reference to FIG. 9 to FIG. 14, the manufacturing method for an optical fiber grating according to the first embodiment of the present invention will be described. This manufacturing method comprises a grating creation step and a phase adjustment step, as mentioned above. The grating creation step is a step of creating the grating sections by irradiating ultraviolet light of which the intensity is modulated at a predetermined period along the longitudinal direction of the optical fiber. The phase adjustment step is a step of adjusting the optical characteristics of the optical fiber grating by irradiating the ultraviolet light only on the phase adjustment sections while monitoring the optical characteristics of the optical fiber grating where the grating sections and the phase adjustment sections are created.

In the above description, an optical fiber, where a material of which the refractive index rises by irradiating ultraviolet light on the core, is used. In the description below, the optical characteristics refers to the reflection spectrum.

FIG. 9(A) is a drawing depicting the grating creation step (step A) for creating the first grating section 226 and the second grating section 228 while securing the portion to be the first phase adjustment section 230. The optical fiber used for creating the optical fiber grating is comprised of a core 210, which is made of germanium added quartz glass, and a clad 212, which is made of glass material of which the refractive index is lower than that of the core 210. The phase grating 214 is disposed on the portion where the first grating section 226 is created, and the phase grating 216 is disposed on the portion where the second grating section 228 is created while maintaining the gap 230 to be the first phase adjustment section, and the shielding masks 218, 220 and 222 are disposed for the portions other than the portions where the phase gratings 214 and 216 are disposed. The phase gratings and the shielding masks are disposed in parallel with the direction of the central axis of the optical fiber.

The phase gratings 214 and 216 are plates made of transparent material, such as quartz glass, that transmits the ultraviolet light, on which periodic bumps are created. The period of the bump structure created on the phase gratings 214 and 216 is determined corresponding to the period of the Bragg gratings to be manufactured, as described below.

Ultraviolet light 224 (first light) with a wavelength of about 240 nm, which is a wavelength sufficient for generating a light induced refractive index change phenomena, is irradiated from above the optical fiber shown in FIG. 9(A). Hereafter, the ultraviolet light with a wavelength of about 240 nm is simply called “ultraviolet light”. By this step A, the first grating section 226 and the second grating section 228 are created with securing the portion 230 to be the first phase adjustment section.

In order to create the grating sections by exposure of a pulse eximer laser with a 248 nm wavelength (beam intensity: 0.5J/cm²) using a commercial optical fiber made of material which causes a light induced refractive index change phenomena (e.g. Photosensitive Fiber™ manufactured by Newport Co.), about a 10 minute exposure is necessary. As an optical fiber made of material which causes a light induced refractive index change phenomena for creating optical fiber gratings for light with a wavelength of about 1550 nm, optical fibers of which an opening ratio of 0.11 to 0.13 and a field diameter of propagation light (diameter of luminous flux in propagation mode of light which propagates through the optical fiber) of 9.6 μm to 11.75 μm are commercialized under such names as F-SBG-15 from Newport Co.

FIG. 9(B) is a diagram depicting the phase adjustment step (step B) for adjusting phase by irradiating ultraviolet light on the first phase adjustment section 230 between the first grating section 226 and the second grating section 228. The shielding masks 236 and 238 are set for portions excluding the first phase adjustment section 230. Once these shielding masks 236 and 238 are set, the ultraviolet light 240 (second light) is irradiated on the first phase adjustment section 230 while observing the reflected light from the first grating section 226 and the second grating section 228 by the reflected light measurement device 247.

The reflected light measurement device 247 is comprised of the optical circulator 245 and the light intensity measuring instrument 246. The light intensity measuring instrument 246 can be any instrument which can observe the spectrum intensity with respect to the wavelength in actual time, such as an optical spectrum analyzer. Now one of the methods of observing the reflected light from the grating sections by the light intensity measuring instrument will be described.

At first the incident light 242 is entered into the core 232 via the optical circulator 245. A part of the incident light 242 is reflected from the first grating section 226 and the second grating section 228 and becomes the reflected light 243, and this reflected light 243 becomes the reflected light 244 via the optical circulator 245 again, and enters the light intensity measuring instrument 246. In this status where the reflected light 244 can be measured, the irradiation of the ultraviolet light 240 is started onto the first phase adjustment section 230 between the first grating section 226 and the second grating section 228. While observing this ultraviolet light 240 by the light intensity measuring instrument 246, the irradiation of the ultraviolet light 240 is ended when the spectrum of the reflected light 244 becomes the desired form. The desired form of the spectrum of the reflected light 244, with which the irradiation of the ultraviolet light 244 is ended, will be described later. In this way, the phase adjustment step (step B) is completed.

FIG. 9(C) is a diagram depicting the grating creation step (step C) for creating the third grating section 262 with securing the portion to be the second phase adjustment section 260 between the third grating section 262 and the second grating section 228. The phase grating 252 is set for the place where the third grating section 262 is created while securing the portion to be the second phase adjustment section 260, and areas other than the area where the phase grating 252 is set are shielded by setting the shielding masks 254 and 256. In this status, the ultraviolet light 258 (first light) is irradiated from above in FIG. 9(C). By this step, the third grating section 262 is created with securing the portion to be the second phase adjustment section 260.

FIG. 9(D) is a diagram depicting the phase adjustment step (step D) for adjusting phase by irradiating ultraviolet light on the second phase adjustment section 260 between the second grating section 228 and the third grating section 262. The shielding masks 268 and 270 are set for the portions excluding the second phase adjustment section 260. Once these shielding masks 268 and 270 are set, the ultraviolet light 272 is irradiated while observing the reflected light from the first grading section 226, second grating section 228 and third grating section 262 by the reflected light measurement device 280. The reflected light measurement device 280 is comprised of the optical circulator 278 and the light intensity measuring instrument 279. For the optical circulator 278 and the light intensity measuring instrument 279, the optical circulator 245 and the light intensity measuring instrument 246, used in the above mentioned step B, can be used.

In this step D as well, the phase is adjusted in a method similar to that in the above mentioned step B. At first, the incident light 274 is entered into the core 264 via the optical circulator 278. A part of the incident light 274 is reflected from the first grating section 226, second grating section 228 and third grating section 262, and becomes the reflected light 275, and this reflected light 275 becomes the reflected light 276 via the optical circulator 278 again, and enters the light intensity measuring instrument 279. In this status where the reflected light 276 can be measured, irradiation of the ultraviolet light (second light) 272 is started onto the second phase adjustment section 260 between the second grating section 228 and the third grating section 262. While observing this ultraviolet light 272 by the light intensity measuring instrument 279, irradiation of the ultraviolet light 272 is ended when the spectrum of the reflected light 276 becomes the desired form. The desired form of the spectrum of the reflected light 276, with which the irradiation of the ultraviolet light 272 is ended, will be described later. In this way, the phase adjustment step D is completed.

As described above, in order to manufacture an optical fiber grating using an optical fiber of which the core is made of material where the refractive index is increased by irradiating ultraviolet light, each step of step A to step D is followed.

In order to manufacture an optical fiber grating using an ion implantation induced refractive index change phenomena, on the other hand, masks, where slits corresponding to the period A of the Bragg grating are created, are used instead of the phase gratings 214, 216 and 252, and an ion beam is used instead of ultraviolet light. In order to execute the phase adjustment steps B and D, the reflection spectrum is observed by the reflected light measurement devices 247 and 280 while irradiating the ion beam on the phase adjustment section, and an optimum ion beam irradiation does is determined. Other aspects are the same as the processing steps for an optical fiber which causes a light induced refractive index change phenomena.

The structure of the optical fiber grating to be created by the above mentioned method and the optical characteristics thereof will now be described. Here using a specific optical fiber grating as an example, the relationship between the refractive index distribution structure and the form of the reflection spectrum thereof, and the status of the change of the reflection spectrum form in the phase adjustment step will be described based on the result of simulation. Through this result of simulation, the effect of the present invention will be described.

The core of the optical fiber to be used is made of germanium added quartz glass, where the core diameter is 4 μm, and the refractive index for the light with a wavelength of 1.553 nm is 1.4511, and the clad is made of quartz glass, where the refractive index for the light with a wavelength of 1.553 nm is 1.445. The effective refractive index for the light with a wavelength of 1.553 nm, which propagates through this optical fiber in basic mode, is 1.44783.

The grating section is created at three locations and the length of each grating section along the central axis of the optical fiber is 4.8 mm, and the refractive index modulation degree (difference An between the refractive index of the high refractive index section and the refractive index of the low refractive index section) is 2.0×10⁻⁴. The geometric length of the phase adjustment section is the length along the central axis of the optical fiber, and is 1.8 mm in this example. In the optical fiber grating, the grating sections are arrayed in the sequence of the first grating section, second grating section and third grating section, and the periods Λ₁, Λ₂ and Λ₃ of the respective Bragg grating are Λ₁=0.53553 μm, Λ₂=0.53567 μm and Λ₃=0.53581 μm respectively. Therefore the respective Bragg wavelengths λ₁, λ₂ and λ₃ are in the relationship λ₁<λ₂<λ₃.

The range of the wavelength of the simulated light (third light) is in a 1548 nm to 1554 nm range, and the reflected light intensity is calculated at each wavelength when the 6 nm width range is divided by 100, and the form of the reflection spectrum is determined.

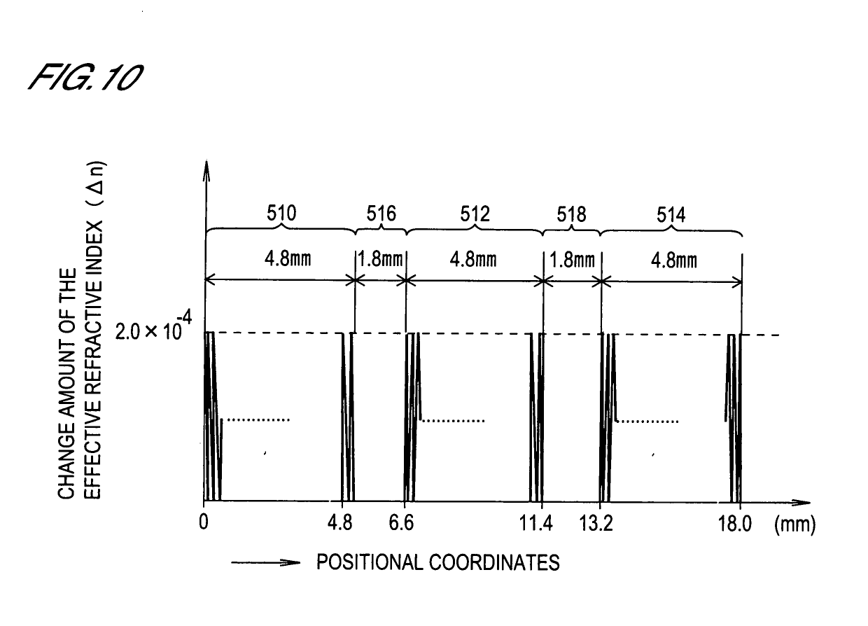

FIG. 10 shows a refractive index distribution structure of the optical fiber grating according to the first embodiment. The abscissa indicates the dimensions of the optical fiber grating in the longitudinal direction in mm units. The ordinate indicates the change amount Δn of the effective refractive index of the optical fiber grating. The change amount Δn of the effective refractive index is the increased amount of the refractive index, which was increased by the light induced refractive index change. In other words, if the ultraviolet light is irradiated on the optical fiber of which the effective refractive index n for the light with wavelength 1.553 nm propagating in basic mode is n=1.44783, and this effective refractive index becomes n+Δn=1.44783+2.0×10⁻⁴, for example, then the increased amount of the refractive index increased by the light induced refractive index change is 2.0×10⁻⁴, so Δn=2.0×10⁻⁴.

In the case of the example of the refractive index distribution structure of the optical fiber grating according to the first embodiment shown in FIG. 10, the refractive index modulation degree Δn is 2.0×10×⁻⁴, which is constant throughout the entire grating section.

In other words, the refractive index distribution of the optical fiber grating according to the first embodiment is given by the following formula.

1.0×10⁻⁴ (1−cos(2πx/Λ)) (3)

Here Λ is a period of the Bragg grating, and the longitudinal direction of the optical fiber is the x axis.

In the optical fiber grating according to the first embodiment, the first grating section 510, first phase adjustment section 516, second grating section 512, second phase adjustment section 518 and third grating section 514 are created in this sequence. The first grating section 510 is created between 0 mm and 4.8 mm on the abscissa, the second grating section 512 is created between 6.6 mm and 11.4 mm on the abscissa, and the third grating section 514 is created between 13.25 mm and 18.0 mm on the abscissa respectively. The first phase adjustment section 516 is created between 4.8 mm and 6.6 mm on the abscissa, and the second phase adjustment section 518 is created between 11.4 mm and 13.2 mm on the abscissa respectively.

The refractive index structure of the first, second and third grating sections are uniformly created as a fine sine curve form at all the locations where each grating section exists, but the structure at both end portions of each grating section is drawn, and the center portion is omitted here.

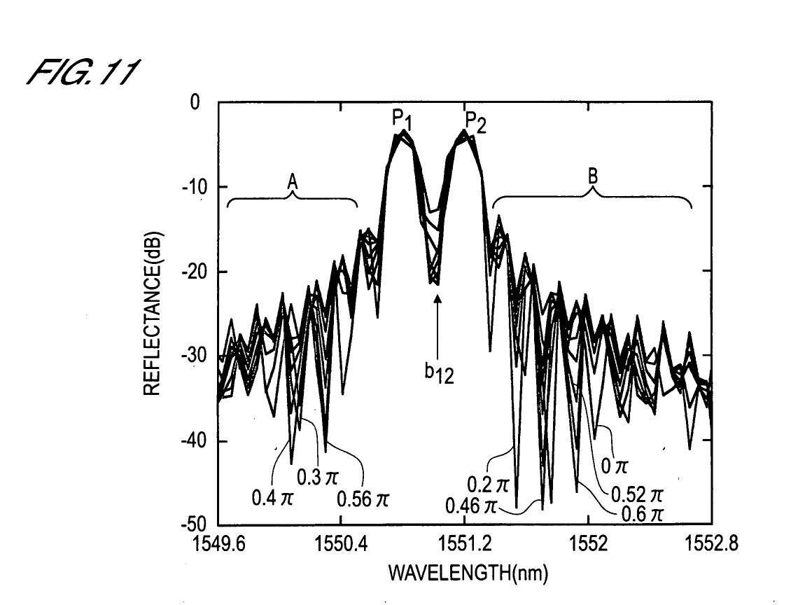

FIG. 11 shows the reflection spectrum corresponding to the Bragg reflection from the first grating section 510 and the second grating section 512. The abscissa indicates the wavelength in nm units, and the ordinate indicate the reflectance in dB. The peaks indicated by P₁ and P₂ correspond to the Bragg reflection from the first grating section 510 and the second grating section 512 respectively. In the reflection spectrum shown in FIG. 11, the curve indicated by 0π is the reflection spectrum which is observed just before ultraviolet light irradiation in the step B described in FIG. 9.

In FIG. 11, the parameters indicated as 0π, 0.2π, 0.3π, 0.4π, 0.46π, 0.52π, 0.56π and 0.6π are the change amount of the optical length, which changes because the refractive index of the portion at the phase adjustment section 516 is increased by irradiating the ultraviolet light, with the optical length of the phase adjustment section 516 just before irradiating the ultraviolet light in the step B as the reference. In other words, the parameter is the value indicated by the phase amount when the length equivalent to the wavelength λ of the light propagating through the optical fiber corresponds to 2π. The status of the change of the reflection spectrum, when the irradiation does of the ultraviolet light is increased using these values as parameters, is also shown.

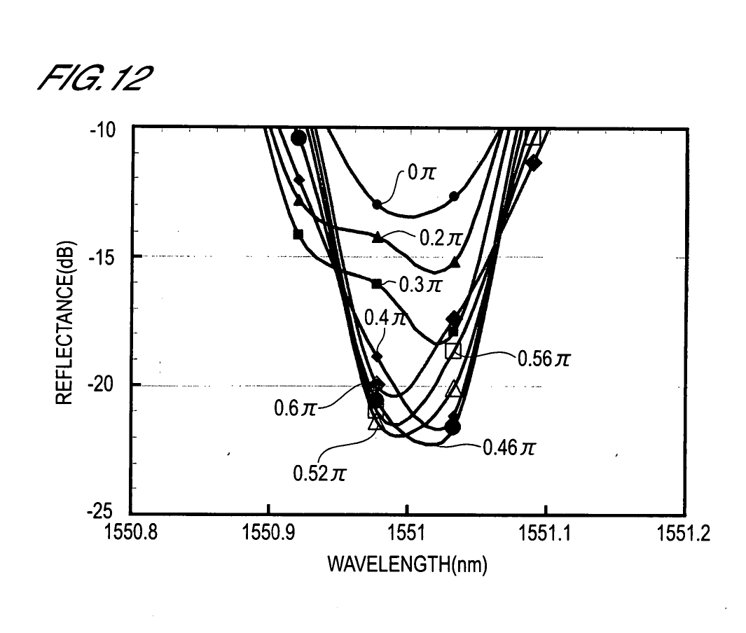

On both sides of the main lobes having the peaks P_{1 and P}₂, side lobes exist in complicated forms in the wavelength areas indicated by A and B, which will be described later, but critical here is the changing status of the bottom b₁₂. FIG. 12 shows an enlarged view of the changing status of the bottom b₁₂ of the reflection spectrum to be observed in the step B.

In FIG. 12, the abscissa indicates the wavelength in nm units, and the ordinate indicate the reflectance in dB. In FIG. 12, the curve, which indicates each reflection spectrum, is indicated by ◯, Δ, etc. in order to easily distinguish the curve which indicates the respective reflection spectrum. As the optical length of the phase adjustment section 516 increases as 0π, 0.2π, 0.3π, 0.4π and 0.46π, since the refractive index of the portion of the phase adjustment section 516 increases by the irradiation of the ultraviolet light, the light intensity at the bottom increases, and from here, as the optical length further decreases as 0.52π, 0.56π and 0.6π, the light intensity at the bottom increases. In other words, if the irradiation of the ultraviolet light is ended in a stage where the optical length of the phase adjustment section 516 has changed (extended) 0.46π in phase difference, then the optical fiber grating which allows obtaining the desired reflection spectrum can be created.

If the irradiation of the ultraviolet light is ended when 0.46π has changed in phase difference, then the light intensity at the bottom b₁₂ between the peak positions P₁ and P₂ can be the smallest, and the main lobes having peaks at P₁ and P₂ can be separated most clearly. In other words, the desired form of the spectrum of the reflected light for determining the end timing of the ultraviolet light irradiation means the form where the light intensity at the bottom is the smallest, and where the main lobes can be separated most clearly.

As described above, the timing to end the phase adjustment step (step B), which was described with reference to FIG. 9, is the stage when the optical length of the phase adjustment section 516 has changed 0.46π in phase difference. This end timing can be determined by irradiating the ultraviolet light (second light) while observing the reflection spectrum by the reflected light measurement device, as described with reference to FIG. 9(B).

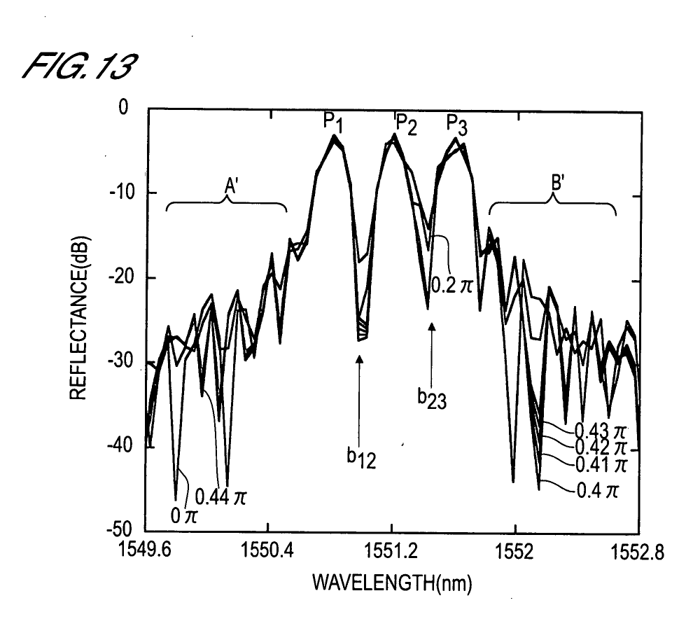

FIG. 13 shows the reflection spectrum corresponding to the Bragg reflection from the first grating section 510, second grating section 512 and third grating section 514. The abscissa indicates the wavelength in nm units, and the ordinate indicates the reflectance in dB. The peaks indicated by P₁, P₂ and P₃ correspond to the Bragg reflection from the first grading section 510, second grating section 512 and third grating section 514 respectively. In the reflection spectrum shown in FIG. 13, the curve indicated by 0π is the reflection spectrum which is observed just before ultraviolet light irradiation in the step D described in FIG. 9.

In FIG. 13, the parameters indicated as 0π, 0.2π, 0.4π, 0.41π, 0.42π, 0.43π and 0.44π are values when the optical length, which changes because the refractive index of the portion at the phase adjustment section 518 is increased by irradiating the ultraviolet light, is converted into the phase amount with the optical length of the phase adjustment section 518 just before irradiating the ultraviolet light in step D as the reference. The status of the change of the reflection spectrum, when irradiation of the ultraviolet light is continued, using these values as parameters, is also shown.

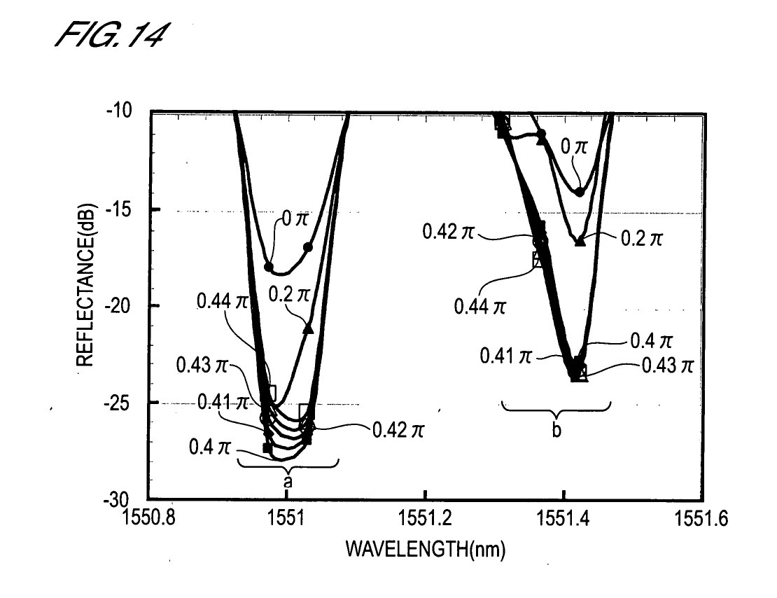

On both sides of the main lobes having the peaks P₁, P₂ and P₃, side lobes exist in complicated forms in the wavelength areas indicated by A′ and B′, which will be described later, but critical here is the changing status of the bottoms b₁₂ and b₂₃. FIG. 14 shows an enlarged view of the bottom b₁₂ and b₂₃ to be observed in step D. In FIG. 14, the enlarged view a indicates the bottom b₁₂ portion and the enlarged view b indicates the bottom b₂₃ portion respectively.

In FIG. 14, the abscissa indicates the wavelength in nm units, and the ordinate indicates the reflectance in dB. In FIG. 14, each reflection spectrum curve is indicated by ◯, Δ, etc. so as to easily distinguish each reflection spectrum curve.

As the optical length of the phase adjustment section 518 increases (extends) as 0π, 0.2π and 0.4π, since the refractive index of the portion of the phase adjustment section 518 increases by irradiation of the ultraviolet light, the light intensity at the bottoms b₁₂ and b₂₃ both decreases, and from here, as the optical length increases as 0.41π, 0.42π and 0.43π, the light intensity at the bottom b₁₂ increases, and the light intensity at the bottom b₂₃ hardly changes.

In other words, if the irradiation of the ultraviolet light is ended in a stage where the optical length of the phase adjustment section 518 has changed 0.4π in phase difference, then the optical fiber grating, which allows obtaining the desired reflection spectrum, can be created. If the irradiation of the ultraviolet light is ended when 0.4π has changed in phase difference, then the light intensity at the bottom b₁₂, between the peak positions P₁ and P₂, can be the smallest, and the main lobes having peaks at P₁ and P₂ can be separated most clearly, and the main lobes having peaks at P₂ and P₃ can also be separated most clearly.

The timing of ending the phase adjustment step (step D), described with reference to FIG. 9, is a stage when the optical length of the phase adjustment section 518 has changed 0.4π in phase difference. This end timing can be determined by irradiating the ultraviolet light (second light) while observing the reflection spectrum by the reflected light measurement device, as described with reference to FIG. 9(D).

Second Embodiment

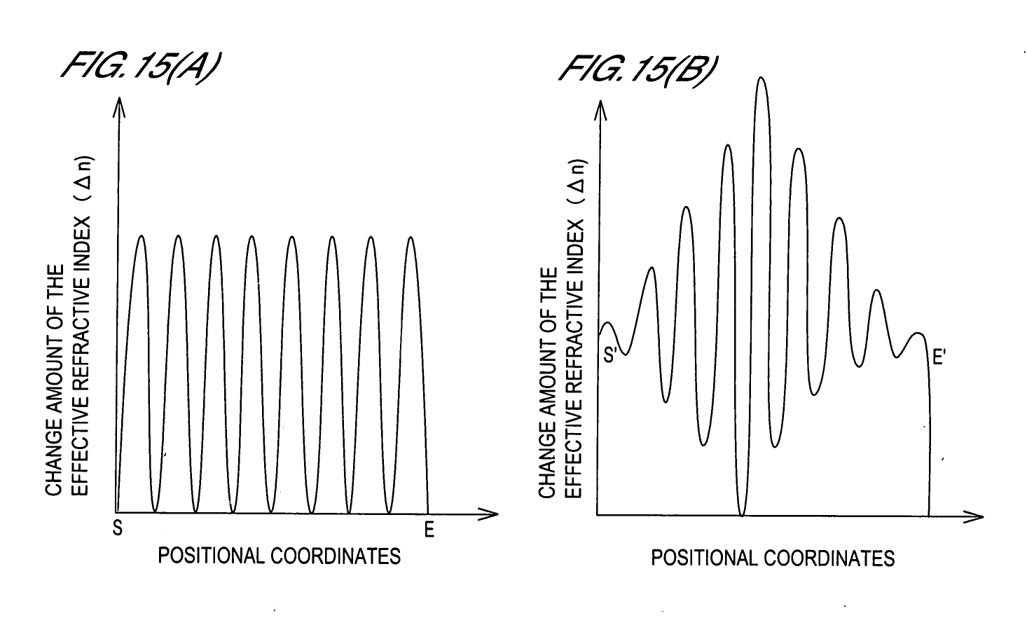

With reference to FIG. 1, FIG. 9, and FIG. 15 to FIG. 23, the manufacturing method for the optical fiber grating will be described, which is the second embodiment of the present invention. This method is also comprised of a grating creation step and a phase adjustment step, just like the first embodiment, but the grating step is different from the first embodiment.

The optical fiber grating 12 comprised of the first grating section 14 and the second grating section 16, as shown in FIG. 1, will be described as an example. As already described with reference to FIG. 9, the first grating section 14 and the second grating section 16 are created using the phase gratings 214 and 216 in step A. The refractive index structure of the grating section to be created in this way will be described using the first grating section 14 as an example. The following description is the same for the second grating section 16 as well.

FIG. 15(A) shows the refractive index distribution structure of the first grating section 14 in the first embodiment. In FIG. 15(A), the abscissa indicates the dimensions (positional coordinates) of the optical fiber in the longitudinal direction, and the ordinate indicates the change amount (An) of the refractive index, both shown qualitatively. The effective refractive index of the portion where the ultraviolet light (first light) is irradiated in the optical fiber, which causes a light induced refractive index change phenomena, is expressed as n+Δn. Here n indicates the effective refractive index of the portion where the ultraviolet light is not irradiated, and Δn indicates the amount of refractive index which was increased by the irradiation of the ultraviolet light.

In FIG. 15(A), the positions indicated by S and E correspond to one end and the other end of the first grating section 14 respectively. In other words, S and E are positions corresponding to the positions indicated as S and E in FIG. 1. The amplitude given by the difference between the maximum and minimum of the change amount (An) of the refractive index is called the “refractive index modulation degree” along the longitudinal direction of the grating section herein below.

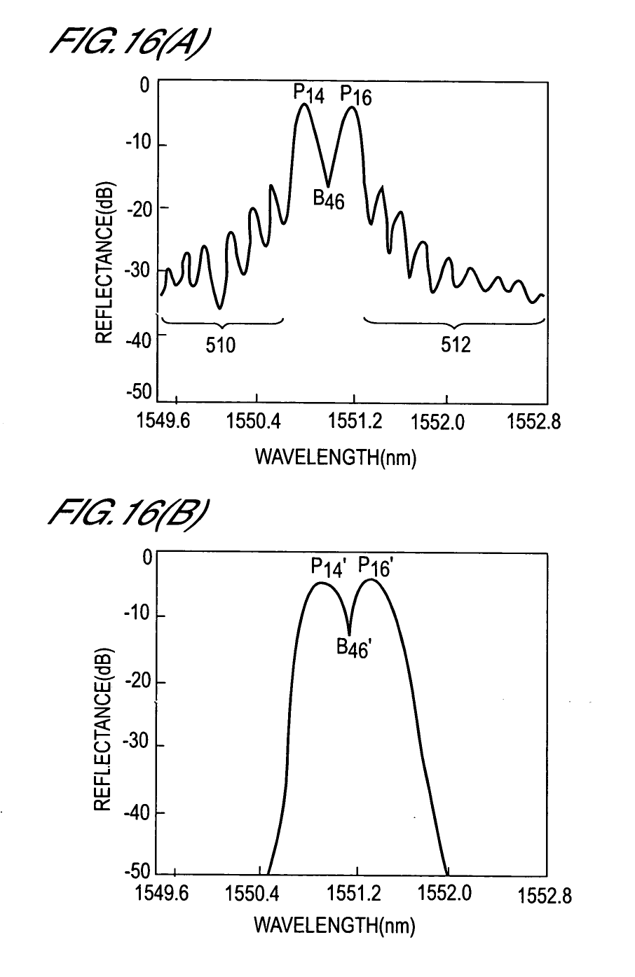

In the refractive index structure of the grating section, which is created in the step A described with reference to FIG. 9, the refractive index modulation degree thereof is constant throughout the entire grating section. The reflection spectrum of the Bragg grating, where the refractive index modulation degree is constant throughout the entire grating section, as shown in FIG. 15(A), is the form shown in FIG. 16(A). In FIG. 16(A), the abscissa indicates the wavelength (nm), and the ordinate indicates the reflectance (dB).

In FIG. 16(A), the peaks P₁₄ and P₁₆, which are appeared at around wavelength 1551 nm, are peaks of the reflection spectrum from the first grating section 14 and the second grating section 16 shown in FIG. 1. Here it is assumed that λ₁<λ₂, that is, Λ₁<Λ₂. In FIG. 16(A), the portions of the wavelength indicated by 510 and 512 are sets of peaks called “side lobes”. The side lobes cause the status where lights with wavelengths that are supposed to be distinguished from each other cannot be perfectly distinguished when optical fiber grating is used as an optical demultiplexer.

It is known that the above mentioned side lobes can be suppressed by creating the refractive index distribution structure of the grating section as follows. That is, the grating section is created such that the refractive index modulation degree becomes smaller approaching closer to both ends of the grating section. Creating the grating section such that the refractive index modulation degree becomes smaller approaching closer to both ends of the grating section is called “apodization”.

In the following description, it is assumed that the first grating section 14 and the second grating section 16, shown in FIG. 1, are apodized Bragg gratings.

FIG. 15(B) shows the refractive index distribution structure of the apodized grating section. In FIG. 15(B), the abscissa indicates the dimensions (positional coordinates) of the optical fiber in the longitudinal direction, and the ordinate indicates the changed amount (Δn) of the refractive index, both shown qualitatively. In FIG. 15(B), the positions indicated by S′ and E′ in the abscissa correspond to one end and the other end of the apodized grating section respectively. These are, for example, the positions indicated by S′ and E′ in FIG. 1. As FIG. 15(B) shows, the changed amount (Δn) of the refractive index becomes smaller approaching closer to the positions indicated by S′ and E′ in the abscissa, compared with the central area of the grating section, so the grating section is created such that the refractive index modulation degree becomes smaller at both ends of the grating section, compared with the central area.

The reflection spectrum of the Bragg grating, where the refractive index modulation degree is created to be smaller approaching closer to both ends of the grating section, as shown in FIG. 15(B), presents the form shown in FIG. 16(B). In FIG. 16(B), just like FIG. 16(A), the abscissa indicates wavelength (nm), and the ordinate indicates the reflectance (dB).

For the grating period, the period of the first grating section 14 is Λₗ, and the period of the second grating section 16 is Λ₂, just like the case without apodization, and it is assumed that λ₁<λ₂, that is Λ₁<Λ₂.

In FIG. 16(B), the peaks P₁₄′ and P₁₆′, which appear around wavelength 1551 nm, are peaks of the reflection spectrum from the first grating section 14 and the second grating section 16 respectively. In FIG. 16(B), a plurality of peaks called “side lobes”, indicated by 510 and 512 in FIG. 16(A), do not exist. However, in the reflection spectrum from the apodized Bragg grating, a half value width of the main lobe becomes wide. Reflecting this, in comparison of the bottom B₄₆ and the bottom B₄₆′ of the reflection spectrum in FIG. 16(A) and FIG. 16(B), the reflectance at the bottom B₄₆ is about −16 dB, whereas the reflectance at the bottom B₄₆′ is about −14 dB, so the light intensity is high. In other words, because of this, the reflected light from the peaks of the reflection spectrum from the first grating section 14 and the second grating section 16 cannot be clearly distinguished.

In other words, by creating an apodized Bragg grating, a plurality of peaks called “side lobes”, indicated by 510 and 512 in FIG. 16(A), no longer exist. Therefore when an optical fiber grating is used as an optical demultiplexer, the status where lights with wavelengths that are supposed to be distinguished from each other but cannot be perfectly distinguished can be avoided. However, the light intensity at the bottom B₄₆′ of the reflection spectrum increases, so a new problem occurs in that it is difficult to separate the reflected light, from the peaks of the reflection spectrum from the first grating section 14 and the second grating section 16.

With the foregoing in view, a decrease in the light intensity at the bottom of the reflection spectrum is attempted in the phase adjustment step, just like the first embodiment.

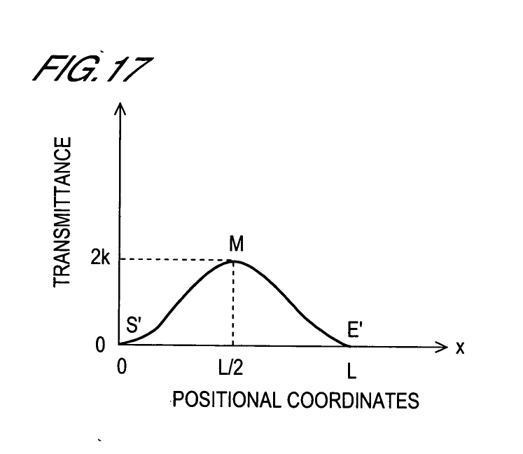

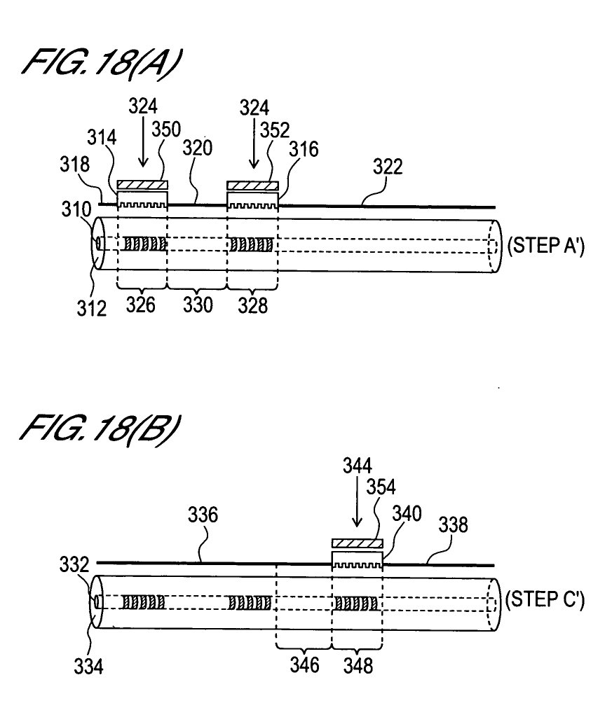

With reference to FIG. 15, FIG. 17 and FIG. 18, a manufacturing method for an optical fiber grating having an apodized grating section according to the second embodiment will be described.

At first, the principle of apodization of the Bragg grating will be described with reference to FIG. 17 and FIG. 15. In FIG. 17, the abscissa indicates the dimensions (positional coordinates) of the optical fiber in the longitudinal direction, and the ordinate indicates the transmittance, both in an arbitrary scale. It is assumed that the length of the grating section is L here. FIG. 17 is a diagram depicting the transmittance characteristic of the transmittance of a distribution mask to be used for executing apodization on the refractive index structure of the grating. The transmittance distribution mask has a cosine function type transmission characteristic expressed by the following formula (4), where the transmittance of the ultraviolet light becomes the maximum at the center part (the point indicated by M in FIG. 17) of the grating section, and becomes the minimum at both ends (the portions indicated by S′ and E′ in FIG. 17) of this grating section.

1−cos (2π/L)x (4)

Here the longitudinal direction of the optical fiber, that is the direction of the central axis, is the x axis. The points S′ and E′ in FIG. 17 correspond to the points S′ and E′ of the optical fiber grating in FIG. 1.

The phase grating and the transmittance distribution mask having this cosine function type transmission characteristic are overlaid, and are used as a mask for ultraviolet light exposure in the grating creation step. Therefore the ultraviolet light intensity becomes smaller approaching closer to both ends of the grating section by the transmittance distribution mask. By this, the ultraviolet light intensity modulation degree, which is created by the mask using the phase grating, also becomes smaller approaching closer to both ends. It is certainly possible to expose using the grating section first by using only the phase grating as a mask, then to expose again using the transmittance distribution mask as a mask, that is exposing in two steps. It is a matter of manufacturing step design as to which method is used, whether exposing with the phase grating and transmittance distribution mask which are overlaid and used as a mask, or exposing in two steps using the phase grating and the transmittance distribution mask independently.

The ultraviolet light intensity modulation degree is the intensity difference between the dark portion and the light portion of the interference fringe of the ultraviolet light, which is created in the core of the optical fiber by phase grating. In other words, the ultraviolet light intensity of the light portion of the interference fringe decreases approaching closer to both ends of the grating section. Therefore the Bragg grating having the refractive index distribution structure shown in FIG. 15(B) is created.

Now a manufacturing method for an optical fiber grating, comprising apodized Bragg grating, according to the second embodiment of the present invention, will be described with reference to FIG. 18. This manufacturing method as well is comprised of a grating creation step and a phase adjustment step, just like the manufacturing method for an optical fiber grating according to the first embodiment. The phase adjustment step is the same as the manufacturing method for an optical fiber grating according to the first embodiment, but the grating creation step is somewhat different.

FIG. 18(A) is a diagram depicting the apodized grating creation step (step A′) for creating the first grating section 326 and the second grating section 328 while securing the portion to be the first phase adjustment section 330. The optical fiber used for creating the optical fiber grating is comprised of a core 310, which is made of germanium added quartz glass, and a clad 312, which is made of glass material of which the refractive index is lower than that of the core 310.

As FIG. 18(A) shows, the phase grating 314 and the transmittance distribution mask 350 are overlaid on the portion where the first grating section 326 is created, and the phase grating 316 and the transmittance distribution mask 352 are overlaid on the portion where the second grating section 328 is created. In this configuration example, the phase grating and the transmittance distribution mask are disposed in this sequence from the optical fiber side. The adjacent phase gratings 314 and 316 are disposed with the gap 330 to be the first phase adjustment section in between. The difference from the grating creation step according to the first embodiment is that not only the phase grating but also the transmittance distribution mask is overlaid and are used together. For the portions other than the areas where grating is created, the shielding masks 318, 320 and 322 are disposed to shield the light to the optical fiber, and in this status the ultraviolet light 324 (first light) is irradiated from above the optical fiber, as shown in FIG. 18(A). By this, the above mentioned apodized Bragg grating is created at the positions of the first grating section 326 and the second grating section 328. Except for overlaying the phase grating and the transmittance distribution mask and being used together, step A′ is the same as step A described in the first embodiment, so a detailed description is omitted.

After the grating creation step (step A′), the phase adjustment step B is executed (this step B is omitted in FIG. 18). Here in order to distinguish from the step B in the first embodiment, the step in the second embodiment corresponding to this step is called step B′.

As described with reference to FIG. 9, the shielding masks are set in the portions other than the first phase adjustment section 330 in step B′ as well. After setting these shielding masks, the ultraviolet light (second light) is irradiated while observing the spectrum of the reflected light from the first grating section 326 and the second grating section 328 by the reflected light measurement device, and ends the irradiation of the ultraviolet light at the point when the reflected light spectrum becomes the desired form. In this way, the phase adjustment step B′ is completed, as described with reference to FIG. 9.

FIG. 18(B) is a diagram depicting the periodic refractive index modulation step (step C′) for creating the third grating section 348 while securing the portion to be the second phase adjustment section 346 between the third grating section 348 and the second grating section 328. The phase grating 340 and the transmittance distribution mask 354 are overlaid on the portion where the third grating section 348 is created, and on the other areas, the shielding masks 336 and 338 are disposed so as to shield the light emitted to the optical fiber. In this status, the ultraviolet light 344 (first light) is irradiated from above the optical fiber, as shown in FIG. 18 (C). By this step C′, the third grating section 348 is created while securing the portion to be the second phase adjustment section 346.

In this step as well, the difference from the grating creation step in the first embodiment is overlaying the phase grating and the transmittance distribution mask and being used together, that is the same as the above mentioned step A′, so description is omitted here.

When this step C′ is completed, the phase adjustment step D, described in FIG. 9, is executed (this step D is omitted in FIG. 18). Here, in order to distinguish from step D in the first embodiment, the corresponding step in the second embodiment is called step D′.

As described in FIG. 9, in step D′ as well, the shielding masks are set in the portions other than the phase adjustment section. After setting these shielding masks, the ultraviolet light (second light) is irradiated on the second phase adjustment section 346 while observing the spectrum of the reflected light from the first grating section 326, second grating section 328 and third grating section 348 by the reflected light measurement device, and ends the irradiation of the ultraviolet light at the point when the reflected light spectrum becomes the desired form. In this way, the phase adjustment step D′ is completed, as described with reference to FIG. 9.

As described above, in order to manufacture an optical fiber grating which has an apodized Bragg grating section, using an optical fiber made of metal of which the refractive index increases by irradiating ultraviolet light on the core, the phase grating and the transmittance mask are overlaid and used in the grating creation step A′ and grating creation step C′, and ultraviolet light is irradiated.

The structure of the optical fiber grating to be created by the above mentioned method of the second embodiment and the optical characteristics thereof will now be described. As described for the first embodiment, the relationship between the refractive index distribution structure and the form of the reflection spectrum thereof, and the status of the change of the reflection spectrum form in the phase adjustment step will be described based on the result of simulation, using a specific optical fiber grating as an example. Through this result of simulation, the effect of the present invention will be described.

As in the first embodiment, the core of the optical fiber to be used is made of germanium added quartz glass, where the core diameter is 4 μm, and the refractive index for the light with a wavelength of 1.553 nm is 1.4511, and the clad is made of quartz glass, where the refractive index for the light with a wavelength of 1.553 nm is 1.445. The effective refractive index for the light with a wavelength of 1.553 nm, which propagates through this optical fiber in basic mode, is 1.44783.

The grating section is created at three locations, and the length of each grating section along the central axis of the optical fiber is 4.8 mm, and the refractive index modulation degree of the grating section is apodized by the cosine function. In other words, the envelope of the curve which provides the refractive index of the grating section is the cosine function. The envelope is given by the above mentioned formula (4).

The geometric length of the phase adjustment section along the central axis of the optical fiber is 1.8 mm. In the optical fiber grating, the grating sections are arrayed in the sequence of the first grating section, second grating section and third grating section, and the periods Λ₁, Λ₂ and Λ₃ of the respective Bragg grating are Λ₁=0.53553 μm, Λ₂=0.53567 μm and Λ₃=0.53581 μm. Therefore the respective Bragg wavelengths λ₁, λ₂ and λ₃ are in the relationship λ₁<λ₂<λ₃.

The range of the wavelength of the simulated light is in a 1548 nm to 1554 nm range, and the reflected light intensity is calculated at each wavelength when the 6 nm width range is divided by 100, and the form of the reflection spectrum is determined.

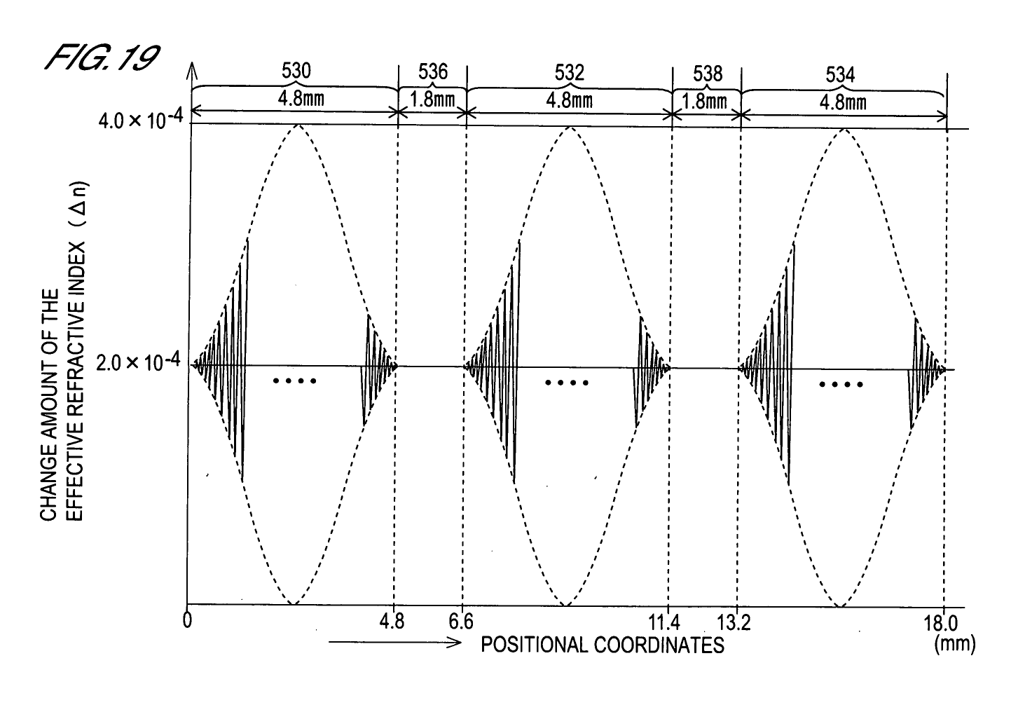

FIG. 19 shows a refractive index distribution structure of the optical fiber grating according to the second embodiment. The abscissa indicates the dimensions of the optical fiber grating in the longitudinal direction in mm units. The ordinate indicates the change amount Δn of the effective refractive index of the optical fiber grating. The change amount Δn of the effective refractive index is Δn=2.0×10⁻⁴, just like the first embodiment. The refractive index modulation degree Δn is the maximum Δn=4.0×10⁻⁴ and the minimum Δn=0, the average is Δn=2.0×10⁻⁴, and the envelope which connects the maximum and minimum positions has the form given by the formula (4).

In the optical fiber grating according to the second embodiment, the first grating section 530, first phase adjustment section 536, second grating section 532, second phase adjustment section 538 and third grating section 534 are created in this sequence. The first grating section 530 is created between 0 mm and 4.8 mm on the abscissa, the second grating section 532 is created between 6.6 mm and 11.4 mm on the abscissa, and the third grating section 534 is created between 13.2 mm and 18.0 mm on the abscissa respectively. The first phase adjustment section 536 is created between 4.8 mm and 6.6 mm on the abscissa, and the second phase adjustment section 538 is created between 11.4 mm and 13.2 mm on the abscissa respectively.

The refractive index structure of the first, second and third grating sections are created at all the locations where each grating section exists, as a fine sine curve form structure where the maximum and minimum positions are connected by the envelope, but the structure at both end portions of each grating section is drawn, and the center portion is omitted here.

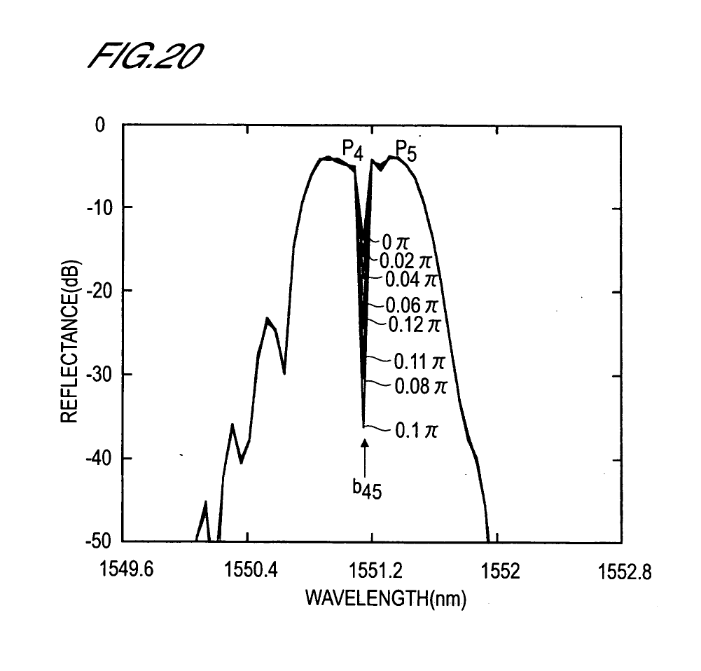

FIG. 20 shows the reflection spectrum corresponding to the Bragg reflection from the first grating section 530 and the second grating section 532. The abscissa indicates the wavelength in nm units, and the ordinate indicates the reflectance in dB. The peaks indicated by P₄ and P₅ correspond to the Bragg reflection from the first grating section 530 and the second grating section 532 respectively. In the reflection spectrum shown in FIG. 20, the curve indicated by 0π is the reflection spectrum which is observed just before ultraviolet irradiation on the phase adjustment section 536 in the above mentioned step B′.

In FIG. 20, the parameters indicated as 0π, 0.02π, 0.04π, 0.06π, 0.08π, 0.1π, 0.11π and 0.12π are the change amounts of the optical length, which changes because the refractive index of the portion at the phase adjustment section 536 is increased by irradiating the ultraviolet light, with the optical length of the phase adjustment section 536 just before irradiating the ultraviolet light as the reference. In other words, the parameter is the value indicated by the phase amount when the length, equivalent to the wavelength λ of the light propagating through the optical fiber, corresponds to 2π. FIG. 20 also shows the status of the change of the reflection spectrum when the irradiation dose of the ultraviolet light is increased using these values as parameters.

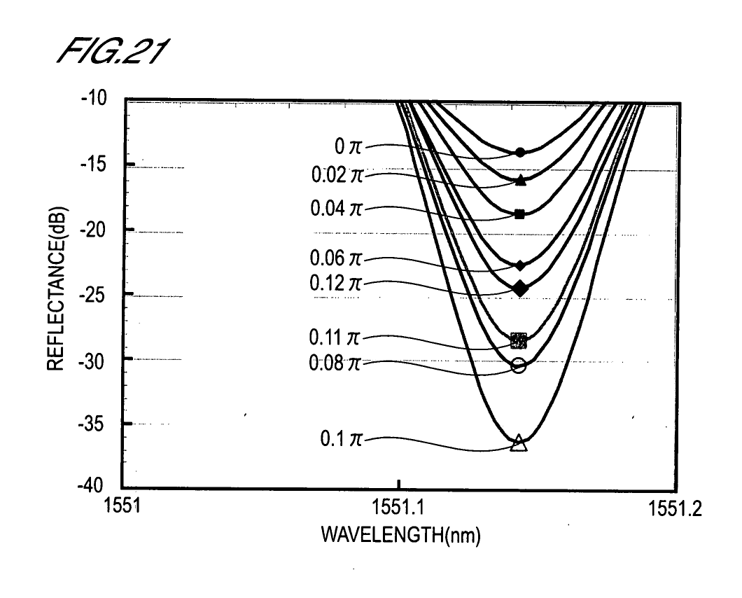

On both sides of the main lobes having the peaks P₄ and P₅, side lobes do not exist, unlike the optical fiber grating of the first embodiment. The changing status of the bottom b₄₅ is critical, just like the first embodiment. So FIG. 21 shows an enlarged view of the changing status of the bottom b₄₅ of the reflection spectrum to be observed in the step of irradiating ultraviolet light on the phase adjustment section 536.

In FIG. 21, the abscissa indicates the wavelength in nm units, and the ordinate indicates the reflectance in dB. In FIG. 21, the curve, which indicates each reflection spectrum, is indicated by ◯, Δ, etc. in order to easily distinguish the curve which indicates the respective reflection spectrum. As the optical length of the phase adjustment section 536 increases as 0π, 0.02π, 0.04π, 0.06π, 0.08π and 0.1π, since the refractive index of the portion of the phase adjustment section 536 increases by the irradiation of the ultraviolet light. The light intensity at the bottom decreases, and from here, as the optical length further increases as 0.11π and 0.12π, the light intensity at the bottom increases. In other words, if the irradiation of the ultraviolet light is ended in a stage where the optical length of the phase adjustment section 536 has changed (extended) 0.1π in phase difference, then the optical fiber grating which allows obtaining the desired reflection spectrum can be created.

If the irradiation of the ultraviolet light is ended when 0.1π has changed in phase difference, then the light intensity at the bottom b₄₅, between the peak positions P₄ and P₅, can be the smallest, and the main lobes having peaks at P₄ and P₅ can be separated most clearly. In other words, the desired form of the spectrum of the reflected light for determining the end timing of the ultraviolet light irradiation means the form where the light intensity at the bottom is the smallest, and the main lobes can be separated most clearly.

As described above, the timing to end the phase adjustment step (step B′), which was described with reference to FIG. 9, is the stage when the optical length of the phase adjustment section 536 has changed 0.1π in phase difference. This end timing can be determined by irradiating the ultraviolet light while observing the reflection spectrum by the reflected light measurement device, as described with reference to FIG. 9(B).

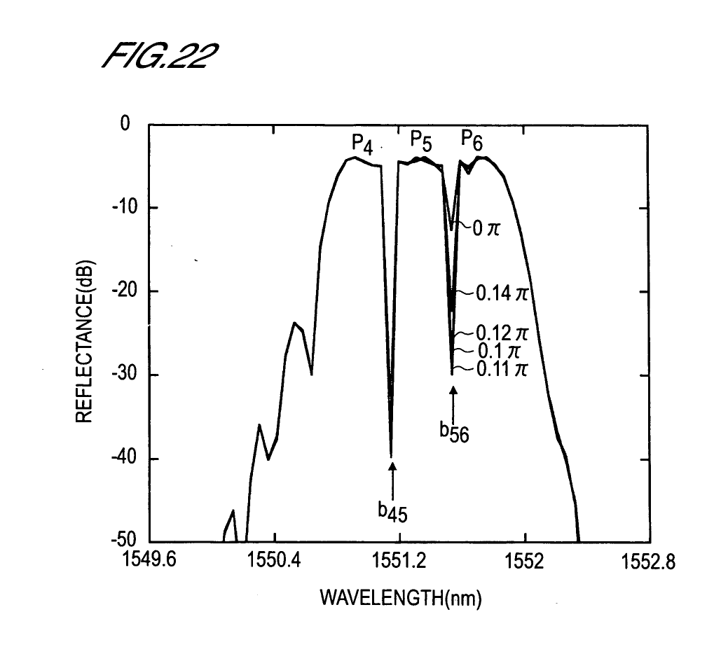

FIG. 22 shows the reflection spectrum corresponding to the Bragg reflection from the first grating section 530, second grating section 532 and third grating section 534. The abscissa indicates the wavelength in nm units, and the ordinate indicates the reflectance in dB. The peaks indicated by P₄, P₅ and P₆ correspond to the Bragg reflection from the first grating section 530, second grating section 532 and third grating section 534 respectively. In the reflection spectrum shown in FIG. 22, the curve indicated by 0π is the reflection spectrum which is observed just before ultraviolet light irradiation. In FIG. 22, the parameters indicated as 0π, 0.1π, 0.11π, 0.12π and 0.14π are values when the optical length, which changes because the refractive index of the portion at the phase adjustment section 538 is increased by irradiating the ultraviolet light, is converted into the phase amount. The status of the change of the reflection spectrum, when the irradiation of the ultraviolet light is continued, using these values as parameters, is also shown.

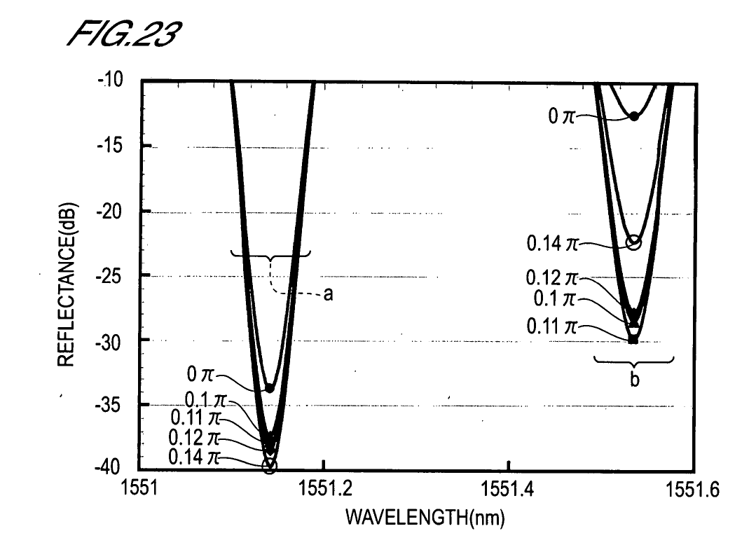

On both sides of the main lobes P₄, P₅ and P₆, side lobes do not exist, unlike the optical fiber grating of the first embodiment. The changing status of the bottom b₄₅ and the bottom b₅₆ is critical, just like the first embodiment. So FIG. 23 shows an enlarged view of the portions of the bottoms b₄₅ and b₅₆ of the reflection spectrum. In FIG. 23, the enlarged view a indicates the bottom b₄₅ portion, and the enlarged view b indicates the bottom b₅₆ portion.

In FIG. 23, the abscissa indicates the wavelength in nm units, and the ordinate indicates the reflectance in dB. In FIG. 23, each reflection spectrum curve is indicted by ◯, Δ, etc. in order to easily distinguish each reflection spectrum curve.

As the optical length of the phase adjustment section 538 increases (extends) as 0π, 0.1π and 0.11π, and since the refractive index of the portion of the phase adjustment section 538 increases by the irradiation of the ultraviolet light, the light intensity at the bottom b₅₆ decreases, and from here, as the optical length further increases as 0.12π and 0.14π, the light intensity at the bottom b₅₆ increases. The intensity of the bottom b₄₅, on the other hand, decreases as the optical length increases as 0π, 0.1π, 0.11π, 0.12π and 0.14π. Therefore if the irradiation of the ultraviolet light is ended in a stage where the optical length of the phase adjustment section 538 has become 0.11π, then the optical fiber grating, which allows obtaining the desired reflection spectrum, can be created.

The light intensity at the bottom b₄₅ decreases as the optical length increases as 0π, 0.1π, 0.11π, 0.12π and 0.14π, so if only the light intensity at this bottom is given attention, it is desirable to end the irradiation of ultraviolet light when the optical length extends further rather than ending the irradiation of ultraviolet light at the point of 0.11π. However, the light intensity of the bottom b₅₆ is stronger than the light intensity of the bottom b₄₅, so it is desirable to end the irradiation of ultraviolet light when the change of the optical length of the phase adjustment section 538 has become 0.11π, at which the light intensity at the bottom b₅₆ becomes the smallest.

As described above, the timing of ending the phase adjustment step (step D′), described with reference to FIG. 9, is a stage when the optical length of the phase adjustment section 538 has changed 0.11π in phase difference. This end timing can be determined by irradiating the ultraviolet light while observing the reflection spectrum by the reflected light measurement device, as described with reference to FIG. 9(D).

As the above description clarifies, if ultraviolet light is continuously irradiated in time only to the phase adjustment section while observing the light intensity at the bottom of the reflection spectrum from the optical fiber grating in the phase adjustment step, the point of time when the light intensity at this bottom becomes the smallest can be determined. If the irradiation of the ultraviolet light is ended at the point when the light intensity at the bottom becomes the smallest, then the optical fiber grating, having characteristics that the light intensity at the bottom wavelength in the reflection spectrum is sufficiently small, can be manufactured.

By executing the phase adjustment step of the present invention to an optical fiber grating having a grating section of which the refractive index modulation degree of the grating section of the optical fiber grating is apodized in order to suppress side lobes, which appear on both sides of the main lobes of the reflection spectrum, then the optical fiber grating, having characteristics that the light intensity at the bottom wavelength in the reflection spectrum is sufficiently small, can be manufactured.

What is claimed is:

1. A manufacturing method for an optical fiber grating, comprising:
a grating creation step of creating grating sections, having a structure in which the refractive index periodically changes along the longitudinal direction of an optical fiber, in said optical fiber, sandwiching a phase adjustment section with changing the period of said refractive index change from one another; and
a phase adjustment step of adjusting the optical length of said phase adjustment section while monitoring the spectrum of the reflectance of the optical fiber grating where said grating sections and said phase adjustment sections are disposed.

2. The manufacturing method for an optical fiber grating according to claim 1, wherein
said optical fiber is an optical fiber comprising a core and a clad which is disposed around said core, where at least one of said core and said clad is made of a material of which the refractive index is increased by irradiating a first light, and
said grating creation step is a step of changing the refractive index at said period along the longitudinal direction of said optical fiber by irradiating the first light at said period along the longitudinal direction of said optical fiber.

3. The manufacturing method for an optical fiber grating according to claim 1, wherein said optical fiber is comprised of a core and a clad which is disposed around said core, wherein at least one of said core and said clad is made of a material of which the refractive index is increased by irradiating a second light, and said phase adjustment step is a step of irradiating said second light only on said phase adjustment section so as to change the refractive index.

4. The manufacturing method for an optical fiber grating according to claim 3, wherein said phase adjustment step is a step of allowing a third light to enter the core of said optical fiber, and allowing the reflected light, which is reflected from the grating section of said optical fiber, to enter a light intensity measuring instrument, and while observing the spectrum of said reflected light by said light intensity measuring instrument, ending the irradiation of said second light at the point when the minimum value of the spectrum of said reflected light between the adjacent main lobes becomes the smallest.

5. The manufacturing method for an optical fiber grating according to claim 4, wherein said third light is entered to the core of said optical fiber through an optical circulator, and said reflected light is entered to the light intensity measuring instrument again through said optical circulator.

6. The manufacturing method for an optical fiber grating according to claim 1, wherein the grating sections are created such that the amount of change of the refractive index of said grating sections becomes smaller when approaching closer to both ends of said grating section.

7. The manufacturing method for an optical fiber grating according to claim 6, wherein said optical fiber is comprised of a core and a clad disposed around said core, and at least one of said core and said clad is made of a material of which the refractive index is increased by irradiation of the first light.

8. The manufacturing method for an optical fiber grating according to claim 7, wherein said grating creation step further comprising a step of overlaying said phase grating and a transmittance distribution mask which has cosine function type characteristics where the transmittance of said first light becomes smallest at the center area of said grating section and becomes the highest at both ends of said grating section, and exposing using these as a mask, or a step of exposing using said phase grating as a mask, then continuously exposing using said transmittance distribution mask as a mask.

9. The manufacturing method for an optical fiber grating according to claim 2, wherein the first light is an ultraviolet light with a wavelength which generates a light induced refractive index change phenomena.

10. The manufacturing method for an optical fiber grating according to claim 7, wherein the first light is an ultraviolet light with a wavelength which generates a light induced refractive index change phenomena.

11. The manufacturing method for an optical fiber grating according to claim 8, wherein the first light is an ultraviolet light with a wavelength which generates a light induced refractive index change phenomena.

12. The manufacturing method for an optical fiber grating according to claim 3, wherein the second light is an ultraviolet light with a wavelength which generates a light induced refractive index change phenomena.

13. The manufacturing method for an optical fiber grating according to claim 4, wherein the second light is an ultraviolet light with a wavelength which generates a light induced refractive index change phenomena.

14. The manufacturing method for an optical fiber grating according to claim 4, wherein the third light is a light of which the wavelength is the same as the wavelength of the light carrier wave.

15. The manufacturing method for an optical fiber grating according to claim 5, wherein the third light is a light of which the wavelength is the same as the wavelength of the light carrier wave.

16. An optical fiber grating to be manufactured by the manufacturing method for an optical fiber grating according to claim 1.
